(19) United States
(12) Patent Application Publication
(10) Pub. No.: US 2026/0219680 A1
(43) Pub. Date: Jul. 30, 2026

(54) AUTONOMOUS UNMANNED AERIAL SYSTEM HAVING CONTINUOUS PATH REGULATOR (CPR) AND ASSOCIATED METHODS

(71) Applicant: BIRKET IP HOLDINGS, INC., Winter Garden, FL (US)

(72) Inventor: David Wayne RUSSELL, Winter Garden, FL (US)

(21) Appl. No.: 19/539,104

(22) Filed: Feb. 13, 2026

Related U.S. Application Data
(63) Continuation-in-part of application No. 17/079,424, filed on Oct. 24, 2020.
(60) Provisional application No. 62/926,518, filed on Oct. 27, 2019.

(51) Int. Cl. G05D 1/646; B64U 20/80; B64U 50/19; G01S 17/933; G05D 1/652; G05D 1/654; G05D 109/20; G08G 5/26; G08G 5/34; H01Q 1/28

(52) U.S. Cl. CPC G05D 1/646; B64U 20/80; B64U 50/19; G01S 17/933; G05D 1/652; G05D 1/654; G08G 5/26; G08G 5/34; B64U 2201/104; G05D 2109/20; H01Q 1/28

(57) ABSTRACT

A UAV includes a preplanned flight trajectory as continuous segments, each segment a parabolic function for X, Y and Z positions projected separately as a function of time. A new position and velocity is computed for each flight segment and the parabolic function is updated for the X, Y and Z positions projected separately as time to correct for any errors in the flight that deviates from its preplanned flight trajectory to bring the UAV back on time, on position and on velocity by the end of that flight segment corresponding to the next successive waypoint as established by the preplanned flight trajectory. The UAV repeats for each respective flight segment to maintain flight of the UAV along the preplanned flight trajectory.

### PRIORITY APPLICATION(S)

This continuation-in-part application claims priority to U.S. patent application Ser. No. 17/079,424 filed Oct. 24, 2020, which claims priority to U.S. Provisional Ser. No. 62/926,518 filed Oct. 27, 2019, the disclosures which are hereby incorporated by reference in their entirety.

### FIELD OF THE INVENTION

The present invention relates generally control system design, and more particularly, to the control of systems where time and position or control signal value are simultaneous required parameters of the control system.

### BACKGROUND OF THE INVENTION

Control system regulators such as the Proportional, Integral, Derivative (PID) controller have been used for decades to provide a simple and reliable methodology for creating a controlled transition from one state of a control signal to another. The time that is required for the transition to take place is variable depending on the differences between to prior state and the next state and loading of the system.

It must be noted, however, that the PID controller is often utilized as a first order approximation of higher order control systems. As such, the tuning required and errors created within the control system because the solution is only an approximation yields less than optimal results such as but not limited to overdamping, underdamping, and/or oscillation.

In other systems, controllers are tasked with transitioning control signals that are inherently part of a trajectory, choreography, or other control system types that require time as one of the required parameters of the control signal. Examples of this abound in robotics, animatronics, and in-flight path management where simultaneous control of when and where a vehicle, joint, or arm is at any point is time is crucial and the timing is invariant.

In these environments a new methodology such as CPR for simultaneously controlling spatial and temporal requirements with high accuracy is needed.

### SUMMARY OF THE INVENTION

An autonomous unmanned aerial vehicle (UAV) may comprise a flight control unit (FCU), vehicle sensors operative with the FCU to provide real time position, orientation and velocity of the UAV during flight, and a UAV flight controller connected to the FCU. Flight actuators may be operative with the FCU and configured to receive a control signal from the UAV flight controller and control UAV flight along a preplanned flight trajectory.

The FCU has stored therein a preplanned flight trajectory that may comprise a trajectory start time and position and a trajectory end time and position within a geographical area of operation (AO) that the UAV operates that is conflict free from flight trajectories of other UAVs operating within the geographical AO. The flight trajectory may include a plurality of preplanned trajectory waypoints defining flight segments, each flight segment comprising a parabolic function for each of X, Y and Z positions projected separately as a function of time. The FCU may be configured to initiate the UAV flight according to the stored, preplanned flight trajectory starting at its preplanned trajectory start time and position and receive data during flight from the vehicle sensors and process real time position, orientation and velocity during flight and for the beginning of each flight segment. The FCU may compute a new position and velocity for each corresponding flight segment and update the parabolic function for each of the X, Y and Z positions projected separately as time for each respective flight segment to correct for any errors in the flight of the respective UAV that deviates from its preplanned flight trajectory. The FCU may also operate the flight controller to control the flight actuators and correct for any deviation in the flight within that flight segment and bring the UAV back on time, on position and on velocity by the end of that flight segment corresponding to the next successive waypoint as established by the preplanned flight trajectory, and repeat for each respective flight segment to maintain flight of the UAV along the preplanned flight trajectory.

The preplanned flight trajectory comprises an Avoidance Limit (AL) as an area around the respective UAV flying its preplanned flight trajectory at every point in time that allows for errors induced by wind and load variations and slight trajectory deviations. For each segment of the flight trajectory, the FCU is configured to update the parabolic function for each of the X, Y and Z positions such that the UAV reaches the next waypoint at the prescribed time and position and stays within the Avoidance Limit. The vehicle sensors may comprise a GPS device and Inertial Measurement Unit having an accelerometer and gyroscope. The vehicle sensors may comprise a LIDAR (Light Detection and Ranging) device that generates 3D map data to the FCU to process for obstacle avoidance within each segment of the preplanned trajectory.

The FCU is configured to generate a new parabolic function as a parabolic curve for each of the X, Y and Z functions that converges to the correct position, velocity and time of the next successive waypoint corresponding to the beginning of the next successive segment in the preplanned flight trajectory. The flight actuators may comprise at least one of drone motors and guidance components. The FCU may be configured to generate a template curve at each flight segment during flight deviations based on a third order polynomial velocity function defining a sigmoid for an actuator control signal having a defined number of actuator steps to achieve an overall change from an initial actuator step value to a final actuator step value defined by the sigmoid, and said flight controller in response is configured to control the vehicle actuators in a non-linear manner to smooth transitions when a flight deviation is required during drone avoidance maneuvers, mid-flight trajectory changes and takeoff/landing corrections.

A system of operating an autonomous unmanned aerial system may comprise a plurality of autonomous unmanned aerial vehicles (UAVs). Each UAV may comprise a flight control unit (FCU) and vehicle sensors operative with the FCU to provide real time position, orientation and velocity of the UAV during flight. A UAV flight controller and flight actuators may be operative with the FCU that control UAV flight along a preplanned flight trajectory. An Air Traffic Controller (ATC) may have an autorouter configured to generate a preplanned flight trajectory for each of the plurality of UAVs operating within a defined geographical area of operation (AO). Each preplanned UAV flight trajectory may have a trajectory start time and position and a trajectory end time and position within the geographical AO. Each preplanned UAV trajectory may be deconflicted from the other preplanned UAV flight trajectories in position, velocity and time such that the preplanned flight trajectory for each UAV is conflict free from the other flight trajectories of other UAVs operating within the geographical AO.

Each UAV flight trajectory may comprise a plurality of preplanned trajectory waypoints defining flight segments, each flight segment may comprise a parabolic function for each of X, Y and Z positions projected separately as a function of time. Each UAV FCU may be configured to receive and store its preplanned flight trajectory before the UAV initiates its flight, initiate the flight of its respective UAV according to its stored, preplanned flight trajectory starting at its preplanned trajectory start time and position, and receive data during flight from respective vehicle sensors and process real time position, orientation and velocity during flight and for the beginning of each flight segment. Each UAV FCU may compute a new position and velocity for each corresponding flight segment and update the parabolic function for each of the X, Y and Z positions projected separately as time for each respective flight segment to correct for any errors in the flight of the respective UAV that deviates from the preplanned flight trajectory. The FCU may operate the flight controller to control the flight actuators and correct for any deviation in the flight of the respective UAV within that flight segment and bring the respective UAV back on time, on position and on velocity by the end of that flight segment corresponding to the next successive waypoint as established by the preplanned flight trajectory, and repeat for each respective flight segment to maintain flight of the UAV along the preplanned flight trajectory and in a deconflicted manner with other UAV's operating within the geographical AO.

### BRIEF DESCRIPTION OF THE DRAWINGS

The novel features believed characteristic of the illustrative embodiments are set forth in the appended claims. The illustrative embodiments, however, as well as a preferred mode of use, further objectives, and features thereof will best be understood by reference to the following detailed description of illustrative embodiments of the present disclosure when read in conjunction with the accompanying drawings, wherein:

FIG. 1 depicts an example of the Velocity/Time equation functions.

FIG. 2 depicts the block diagram of an exemplar control system.

FIG. 3 depicts a 3D plot of the trajectory in X, Y, Z related to Latitude, Longitude, and Altitude.

FIG. 4 depicts a plot of the Z samples taken from the trajectory.

FIG. 5 depicts a plot of the splines providing a mathematical fit of the Z trajectory.

FIG. 6 depicts the transfer function of the first second of the exemplar trajectory.

FIG. 7 depicts the transfer function of the second sample of the exemplar trajectory.

FIG. 8 depicts the transfer function of the third sample of the exemplar trajectory.

FIG. 9 depicts the trajectory sample locations and actual path of the first five seconds of the exemplar trajectory.

FIG. 10 depicts the control velocity curve of the first five seconds of the exemplar trajectory.

FIG. 11 depicts the total plot of sample locations and actual path for the full trajectory.

FIG. 12 depicts the velocity curve of the full trajectory.

FIG. 13 depicts the addition of random wind as external forces acting on the simulated trajectory.

FIG. 14 depicts the total plot of planned locations and actual path with wind.

FIG. 15 depicts a zoomed-in plot of one section of the planned trajectory and actual path with wind.

FIG. 16 depicts the control velocity curve with wind for the full trajectory.

FIG. 17 depicts full trajectory with wind and the second error function added.

FIG. 18 depicts a zoomed-in plot of one section of the planned trajectory and actual path, wind, and second error term added.

FIG. 19 depicts a plot of the second error term reacting to the injected wind velocity.

FIG. 20 depicts the control velocity output with wind and second error term.

FIG. 21 depicts the calculated polynomial used as the template for the entire solution.

FIG. 22 depicts a sigmoid function that may be used to match disjoint control signals.

FIG. 23 is a four-dimensional (4D) trajectory of an example of the CPR system in accordance with a non-limiting example.

FIGS. 24A-24C show the respective velocities for the trajectory in the X, Y and Z axis for the first segment as shown in FIG. 23.

FIGS. 25A-25C show the velocity graphs for the second segment of FIG. 23.

FIG. 26 is a graph showing the trajectory points for the segments in FIG. 23.

FIGS. 27A-27C show the velocity parabolas for the X, Y and Z axis with the velocity changes.

FIG. 28 is a graph showing the trajectory points with arc circles for the segments of FIG. 23.

FIGS. 29A-29C show the velocity parabolas and time in the example of the trajectory in FIG. 23.

FIG. 30 is a graph showing the trajectory points with arc circles at another time period.

FIG. 31 shows the matrix equations A and y and the A/y coefficients together with the a and b coefficients.

FIG. 32 is a three-dimensional view of a cityscape with random flight plans implemented as mathematical splines.

FIG. 33 is a block diagram of a drone with a flight control unit and guidance system components and the drone traffic control flight center that operates the autorouter system.

FIGS. 34-39 are images for an example of the CJR system trajectory as an example.

FIG. 40 is a graph showing an example of a 4D trajectory that is planned by the autorouter system in accordance with a non-limiting example.

FIGS. 41A and 41B show an example of graphs for a drone straight trajectory and its turn with lower velocity when velocity and acceleration curves are added to trajectory segments in accordance with a non-limiting example.

FIGS. 42A and 42B show an example of graphs for the drone landing.

FIGS. 43A-43D show a 4D trajectory split into independent functions with respect to time.

FIGS. 44-47 show graphs for the CJR system that processes a parabolic velocity curve in accordance with a non-limiting example.

FIGS. 48A-48C are diagrams that compare different routing systems established in a flight plan generator for application to a drone.

FIGS. 49-52 are examples of autorouter routing and a simulation in FIG. 52 showing the chaotic nature of trajectories using prior art detect and avoid.

FIG. 53 is a bar chart showing the errors as a function of drones in an area.

FIGS. 54-58 are graphs showing the control signal response for the CJR system in accordance with a non-limiting example.

### DETAILED DESCRIPTION

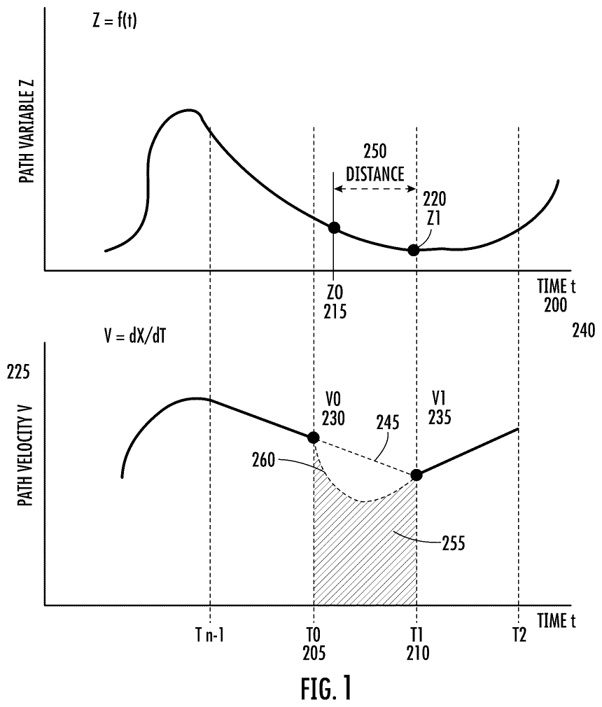

Referring now to the invention in more detail, in FIG. 1 there is shown a graph depicting the relationships between the distance, velocity, and time parameters of the control system. The different illustrative embodiments recognize and take into account a number of different considerations. “A number” as used herein with reference to items means one or more items. For example, “a number of different considerations” means one or more different considerations. Unless otherwise noted X and Y are intended to reference ground width and breadth as in a Cartesian coordinate system, and Z is intended to reference altitude, height, or altitude Above Ground Level (AGL). The spatial orientation could be other orientations such as NED (North, East, Down as designations of X, Y, and Z respectively without changing the intent of the invention.

The number of physical and temporal dimensions are shown as three (3) or more for illustrative purposes, however more or fewer physical and multiple temporal dimensions are possible without altering the intent of the invention. While the words “flight path” may be used for illustrative purposes, the physical and temporal dimensions of the resultant trajectory may be utilized in any environment with moving parts from flight vehicles to surface vehicles to self-adjusting shelving. One or more dimensions of control signals which do not relate to physical or Cartesian coordinates are also possible.

There are two aspects of higher dimensional and higher order system that need to be recognized. First that a control system may be equally dependent on time as one dimension as it is dependent on one more physical dimensions such as those referred to by Cartesian coordinates often denoted as X, Y, and Z. Secondly, the transfer function from one state to another may not be a first order equation such as Y=mX+b but higher orders such as aX∧2+bX+c.

In order to create a “Correct by Construction” solution to these problems, the system must first be able to define the overall control structure mathematically, and then find an exact solution. To define the control structure, the system will first define a trajectory.

The trajectory of a control system defines the physical and temporal mathematical equations which govern the control system at any instant of time, and indeed at every instant of time within the limits of the trajectory. This can be derived from a number of physical points, with the understanding that the greater number of points given the closer the system becomes to being described by these mathematical equations. For example, two endpoints describe a line such as Y=mX+b. Three points can describe a curve such as aX∧2+bX+c. More points can be used to create one spline which may be of arbitrary higher order or a series of lower order splines that can describe any path through space with mathematical precision. A single spline or sequence of splines mathematically fills in the gaps between the smaller subset of given points in the Cartesian domain. In a Cartesian trajectory these sample points are often referred to as Waypoints.

In this embodiment, each trajectory is conceptualized as a segment with a given average velocity. This velocity value could be a constant, graph, spline, or series of splines or line segments or other mathematical construct. The geometric order of the segment is dependent on the desired results, and one familiar with the art would see that a first order line segment, i.e., Y=mX+b or a second order segment such as Y=aX∧2+bX+c or higher order representations make no difference to the operation of the system as described. In another embodiment the assigned velocity could also be an equation of any given order or a spline or series of splines. The only requirement is that both the trajectory and the time element are expressed mathematically such that at any given time an exact value of the trajectory may be determined. In other embodiments the time given could be a factor related to time or can be mathematically computed from time such as but not limited to velocity or acceleration.

In order to simplify the architecture and computational complexity, this embodiment utilizes the fact that any system of multiple variables may be expressed in relation to an additional arbitrary variable. As velocity is one of the factors, the system wants to preserve with each segment and velocity is a derivative relative to time, the system can express each segment as a multivariate: X=f(T); Y=f(T); and Z=f(T). In so doing, the system has integrated all four dimensions within a single computational structure.

The final trajectory from source to destination will be an ordered list of each of these segments. In this embodiment the path will be defined as a series of splines, which provides an additional benefit in that the splines can be defined such that the velocity at the “knots” or transition points is constant. This is of great benefit to defining the paths of moving vehicles. In other embodiments different types of averaging splines, polynomials, lists, matrices, vectors or other mathematical forms might be used to express the trajectory.

Trajectories are also of use in describing the path and timing (distance, velocity, acceleration) of moving components in robotics or in trying to mimic human-like movement in an animatronic figure. This is one case where the exact movement of the figure with respect to time is critical. Trajectories can also be created for other than Cartesian domains such as complex control signals managing multivariate electronic components over time.

Once the trajectory is created, the question becomes how to create a mathematical solution that exactly meet the requirements of that trajectory.

In this embodiment, which is depicted in FIG. 1, the control system is designed to sample one dimension of the trajectory (here the system will use Z although any other dimension is roughly equivalent) with respect to time (T), as shown above that relationship is defined as Z=f(T). The sample period will be defined as T1−T0. From the trajectory, each point in Z can be solved from the Z=f(T) equation such that Z0 is the initial position of the system at T=T0 and Z1 is the position of the system at T1.

Because the trajectory contains the position for all points of Z over time, it is also true that Z2 will be the position of the system at T2 where for this embodiment T2−T1=T1−T0 although this is not a requirement. The calculation can also be simplified such that T0 can be denoted for any point N in the limits of the trajectory and point N1 is denoted at T1. At the next consecutive sample, T1 becomes T0, T2 becomes T1, and the calculations continue.

The system can then postulate a system where the initial state exists at T0, Z0, and an initial velocity V0. At the beginning of the trajectory V0 may be equal to 0, but as it will be shown V0 can be any velocity as the control system operates. It is often the case that V1 may also be 0 at the end of the trajectory, although there is no requirement as such.

The end state of the system at T1 consists of time T1, location Z1, and from Z2-Z1, the system can formulate the output velocity of this state as V1.

This provides us with the mathematical requirement that the control system will provide the transition signal, in this embodiment the velocity of the Z dimension, such that the Z dimension travels from Z0 to Z1 and the velocity transitions from V0 to V1 during the exact time T0 to T1. In another embodiment, any one of the dimensions such as but not limited to distance (here Z), velocity (V) and Time (T) can be used as the variable with which to control one of the other three. This provides considerable freedom to vary the system to the control system circumstanced required, such as but not limited to varying the sample frequency instead of the velocity to control distance.

For this to occur, the system will utilize a curve of the velocity of Z, aZ∧+bZ+c=0. The distance traveled from Z0 to Z1 is equal to the area under this curve between T0 and T1. That area can be found by integrating the function and evaluating at the given time. The system knows from Z1−Z0 the distance to be traveled which is equal to the area under the curve.

The system then has two equations and two unknowns:

aZ∧2+bZ+V0=0 (c=V0 at Z=0)

The integral of (aZ∧2+bZ+V0=0)=(Z1−Z0). When the integral is evaluated between T0 and T1 the result equals Z1−Z0.

This can be solved for (a) and (b), which gives us the exact solution for the transfer function of the velocity at V0 to the velocity at V1 with the exact distance covered Z1−Z0 in the time sample T1−T0.

Once the control system reaches T1, the calculation is set such that T1 becomes the new T0, Z1 becomes Z0, V1 becomes V0 and the next sample window determines the new parameters for T1, Z1, and V1 from the trajectory functions.

This equation is tolerant of any transitory phenomena (within one sample time) that might occur due to external environmental forces, internal numerical errors, or mechanical issues such as propeller or motor imbalance.

This cycle can be maintained from one sample time to the next throughout the trajectory yielding an exact numerical control for simultaneously maintaining the correct position and time.

FIG. 1 depicts the foundation for the CPR. In this embodiment, the horizontal axis 200 is Time, from T0 205 to T1 210. The system will also depict the horizontal axis as Distance 250, from Z0 215 to Z1 220. The vertical axis 225 is Velocity. The left edge T0 intercept is V0 230 and the right edge T1 intercept is V1 235. In this exemplar typical of one time step of the regulator, the final actual velocity prior to this step was V0 (regardless of whether this was the average or anticipated velocity for that segment) and the average velocity calculated for the next segment is V1. The actual endpoint of distance from the last time step is Z0, again regardless of the expected end location of the step. The expected start of the next step is Z1.

In another embodiment, the V1 values may be stored or otherwise calculated from data, data structures, or metadata embedded with the trajectory or available to the system in other ways. In another embodiment the temporal distance denoted by T1 and T0 may vary without changing the intent of the invention. Indeed the equations given above work independent of the magnitude of any of the variables with the exception the T1>T0 and Z1>Z0. As the velocity V is dependent of distance divided by time, V may be any magnitude or sign.

The purpose of the regulator then is to manage the transition from Z0 to Z1, in the exact time period of T1−T0, and to match the start and end velocities of V0 and V1 respectively. In this example, the system poses the problem that the previous time step ended at a higher velocity than anticipated. The reason is immaterial. As such V0>V1 and Z0 is offset into this region such that the distance to be traveled in this step is now shorter than originally scheduled, while the time period for traversing that distance remains the same.

The ultimate goal of every calculation is to provide the exact requirements for Z to reach Z1 with velocity V1 at T1, regardless of the input conditions. As can be seen in FIG. 1, the dotted line 245 would represent the first order transition from V0 to V1. If this path were taken the distance traveled would be equal to the area under the line 255, which is (T1−T0)*(V1+((V1−V0)/2)). This distance cannot be smaller than the average velocity anticipated for the period, as is required by the advanced position of Z0 and the higher initial velocity.

It is then evident that the velocity transfer function from V0 to V1 must be a curve 260, which must fall below V1 in order to bleed off the excess speed, and then rise again to make the required exit velocity of V1. This observation provides the first equation for the numerical solution, i.e., the path of the velocity transfer function must be a curve such as but not limited to aZ∧2+bZ+c=0.

The second equation is then that the total distance traveled in this time period is represented by the area under the curve 255 (hatched area) evaluated from T0 to T1, and this in turn is equal to Z1−Z0. That can be represented as the integral of the first equation evaluated between T0 and T1. As the lowest point of this line must fall below V1 in order to reduce the excess speed, this also shows that the area under the simple transition line 245 cannot equal the distance 250.

Calculating the simultaneous solution to these two equations yields the calculations represented by the first computation block, where X here represents the input value of any dimension and V represents the first derivative of that signal value as described above:

(a)=3*(2X0−2X1−T0V0−T0V1+T1V0+T2V1)/(T0−T1)∧3

(b)=2*(3X0−3X1−2T0V0−T0V1+2T1V0+T1V1)/T0∧2−2T0T1+T1∧2

(c)=V0

This transfer function curve provides a mathematically exact solution to traversing the requisite space between Z0 and Z1 in time T1−T0, with the initial and final velocities required.

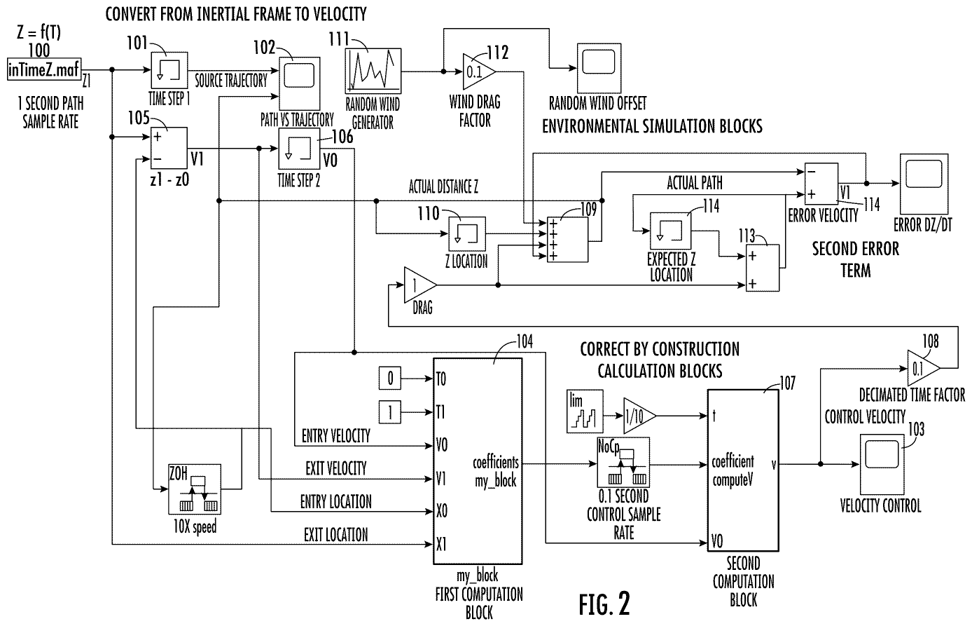

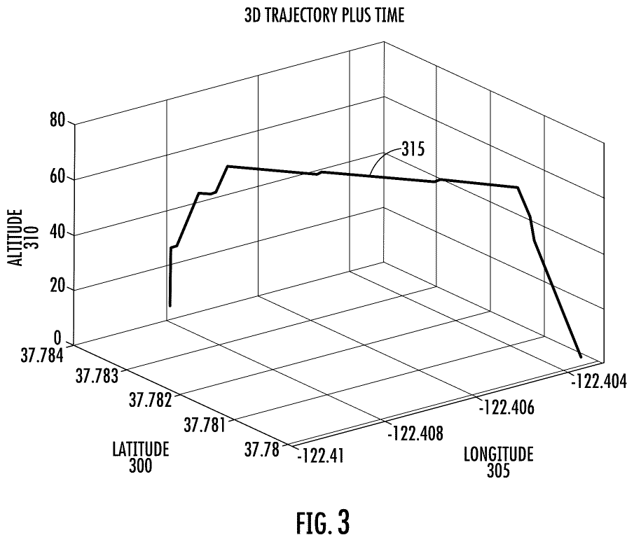

FIG. 2 depicts the flow diagram of an embodiment of a Continuous Path Regulator (CPR) control system for an exemplar trajectory. The full trajectory is shown in FIG. 3. In this diagram, the spline version of Z=f(T) is evaluated each second (trajectory sample time) 100 and is sent to the control system. Storage elements of the regulator are loaded with the initial Z0 value as well so that most initial difference calculations result in 0. Two storage time steps are then delayed 101 106 in order to get the Z1 and Z2 values into the controller as well. In some embodiments, these could all be done in the same step and/or without delay. When Z2 is loaded the controller begins providing velocity data for the flight path 102 103. The first calculation block 104 receives the entry velocity V0 calculated from Z1−Z0 105 and then stored for the next time period 106. The first calculation block also receives the exit velocity V1, calculated in the same manner in the next time step. Similarly the initial Z position Z0 and final Z position Z1 are presented to the first calculation block. At the end of the time period T1, the V1 data is stored replacing V0 and a new V1 is calculated.

In this embodiment, the T0 and T1 variables are always set to 0 and 1, respectively as the time is held constant to the sample time of the trajectory while other variables interact. This is not a necessary condition, in this embodiment it simplifies the controller design to some extent. The outputs of the first calculation block are the parameters (a) and (b) relating to the equation aZ∧2+bZ+c. C is known to be equal to V0, so V0 is presented directly to the second computation block 107. The second computation block is clocked at a higher rate than the first, in this embodiment 10×, but one familiar with the art would see that different sampling ratios would not alter the fundamental aspects of the invention.

The second computation blocks evaluates the velocity curve given by (a) and (b) output by the first computation block, and provides the values represented between T0 to T1 in 0.1 second intervals. Because of the decimation subsampling, each velocity output provided is multiplied 108 by 0.1 so that the total velocity imparted is the same as (Z1−Z0)/(T1−T0). This is not a gain per se, but a computation step exactly compensating for the decimation subsampling.

To correctly simulate the resultant movement given the velocity setting of the second computation block, an arbitrary drag coefficient 108 may be applied to the velocity setting. A drag coefficient of 1 would have no effect on the velocity target setting. The velocity is then summed with previous Z locations 109 and stored. This provides the system with the amount of Z distance covered by the velocity for each time step. In addition, a random simulation of wind velocity 111 with a wind drag coefficient 112 is added in the distance computation path.

The stored value of the Z location plus the velocity for each time tick is fed back into the controller as the next Z0 and as the basis of the next V0. This completes the computation and feedback loop of the controller. Any errors in position and/or velocity are compensated for in the next time period.

In this embodiment a second error term is shown as velocity summation cycle 113, 114. This is a computation of the expected distance that the original velocity setting would have achieved without external forces such as wind. The difference 115 between this calculation of the expected distance and the actual distance results in a velocity error term which is fed back into the system. The nature of this error term will be described more fully below.

To demonstrate how this works in a complete regulator, FIG. 3 depicts a three-dimensional trajectory with Latitude 300, Longitude 305, and Altitude 310 as the Cartesian coordinates. The trajectory 315 is shown varying in all three dimensions. In addition, an average velocity of 1 m/s is applied such that nearly 500 m of distance would be covered in 500 seconds.

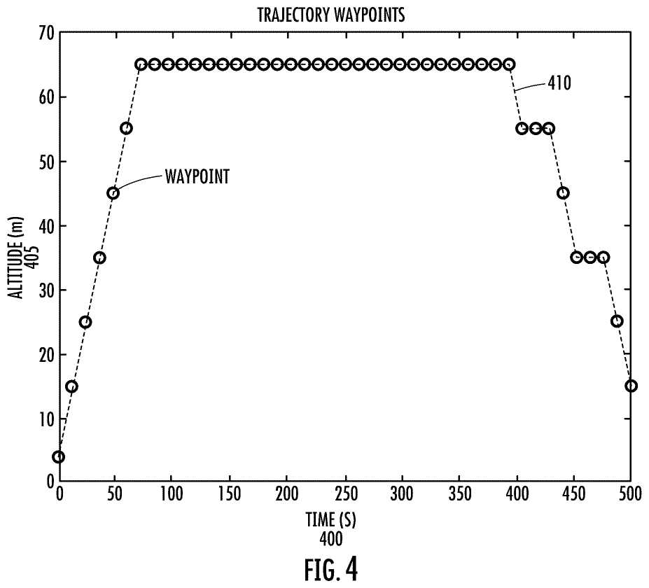

FIG. 4 depicts the Altitude dimension as Z=f(T). Time 400 is the horizontal axis, and Altitude 405 or Z is the vertical dimension. The original trajectory waypoints created by the flight planning system are shown as circles 410. Note that these waypoints are a subset of the entire path as shown by the dotted lines.

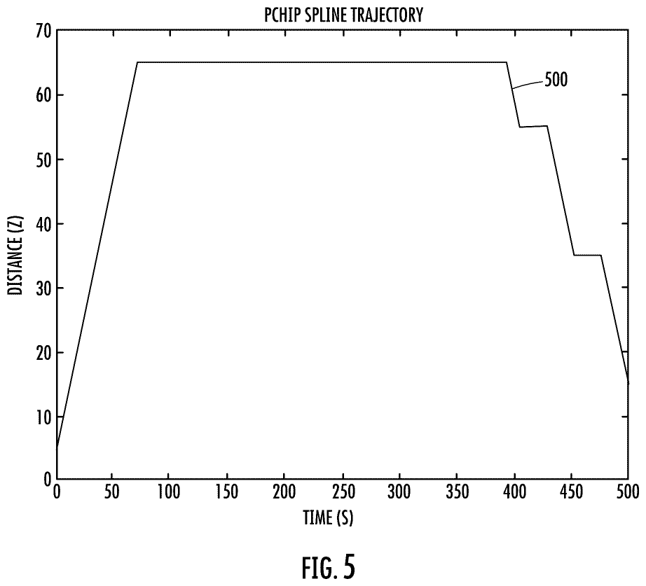

FIG. 5 depicts the same trajectory converted to a Piecewise Cubic Hermite Interpolating Polynomial, although one familiar with the art would note that the actual interpolation algorithm utilized or value storage system employed would not change the fundamental operation of the invention. The polynomial solution, however, provides any necessary solution to Z=f(T) for the regulator. In other embodiments the polynomial could be represented by higher order polynomials including but not limited to splines, or vectors or matrices of individual values that are known a priori because the time steps are known.

In this embodiment and exemplar trajectory, the system functions as follows:
In the first second of operation, the values for Z0, Z1, V0, and V1 are determined and/or loaded from the trajectory information. T0 and T1 will always equal 0 and 1 in this implementation. From the Z trajectory given in FIG. 5,
Z0=4 m (Initial altitude AGL)
Z1=4.09 m (the flight planning system starts off with slow takeoff)
V0=0 (vehicle at rest)
V1=0.0892 (the average velocity of the next section of the trajectory, (Z2−Z1)/t.

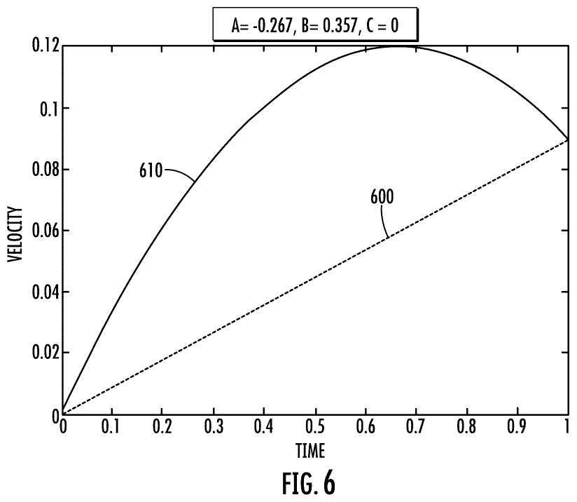

This yields the solution of (a)=−0.267 (b)=0.357 and (c)=0 as graphed in FIG. 6. Here the dotted line 600 again shows the first order approximation of the transfer function from V0 to V1 and the parabola 610 depicts the exact transfer function such that the area under the curve is 0.09 m in one second. This shows that while the average velocity may be used as an overall target, the actual velocity is determined by the transfer function as per the time and distance requirements of that sample period. In another embodiment the actual velocity of the system at V1 might be known a priori, or the velocity profile may be other than a constant. The purpose of V1 is simply to keep the exit in bounds, any error in V1 will be compensated for in the next sample solution.

In the second time period,
Z0=4.09 m
Z1=5.01 m
V0=0.0892 m/s
V1=0.919 m/s

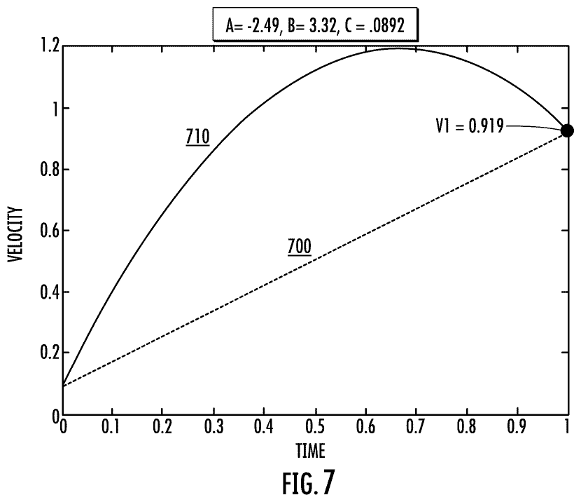

Which yields the parameters (a)=−2.49 (b)=3.32 (c)=0.0892 as shown in FIG. 7.

In the third time period, as shown in FIG. 8 a=0.102, b=−0.135, and c=0.919. Note that the first two parabolas opened downward, but here it opens upwards. The velocity polynomial can work either way to provide the appropriate transfer function.

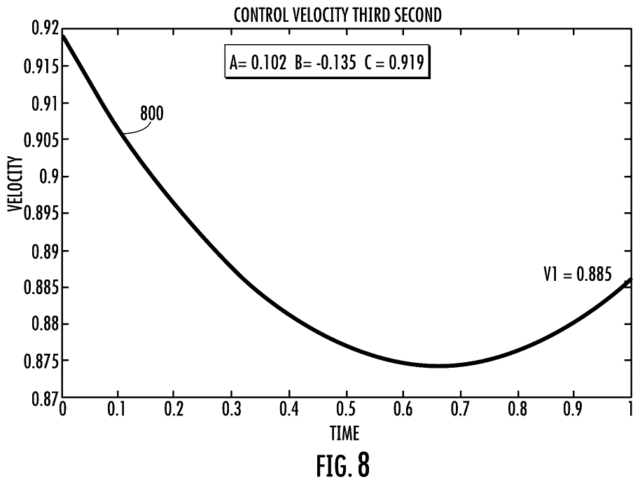

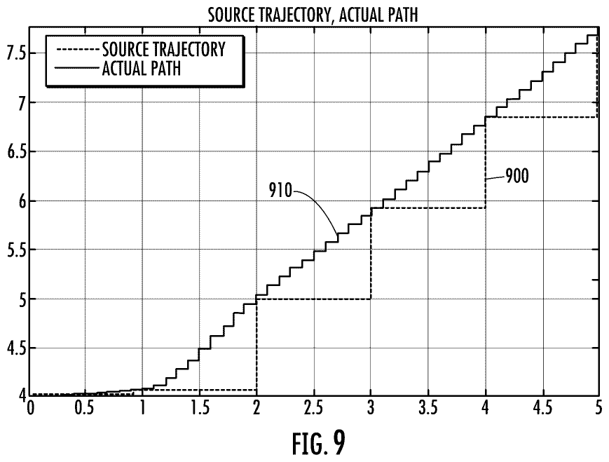

A comparison of the source trajectory 900 and the actual path simulated 910 for the first five seconds is shown in FIG. 9. This shows that the actual path follows the spline or polynomial path with high precision even though it is sampled only once per second, resulting in the stairstep plot. Because of this slow sampling rate, the error is only sampled at these points. The consequences of this slow sample rate will be detailed below. In other embodiments the sample rates may vary, or the first and second computation blocks may be at the same higher sample rate comparing against the trajectory also sampled at a higher rate. In another embodiment the sample rates may vary depending other information such as but not limited to the velocity rate of change, error rates, or ranges of values.

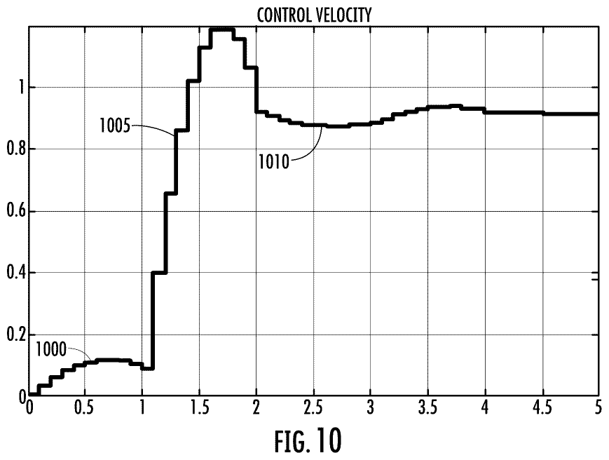

FIG. 10 depicts the velocity control signal for the first 5 seconds. The two positive velocity parabolas are easily identified at (T=0) 1000 and (T=1) 1005 and the negative velocity parabola is evident at (T=3) 1010. The initial three seconds highlight how the parabolas are required to reach the proper velocities at T1, T2, and T3.

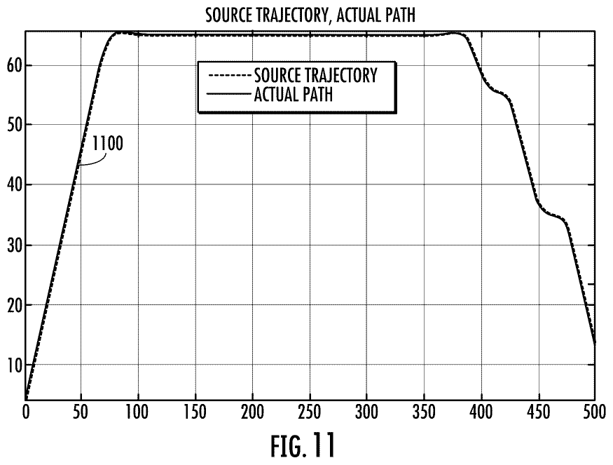

FIG. 11 shows the correlation between the source trajectory 1100 and the actual path for the entire trajectory. Note that this is without any external velocities applied, but it still shows a mathematical error of 0 for the simultaneous solution of location and time.

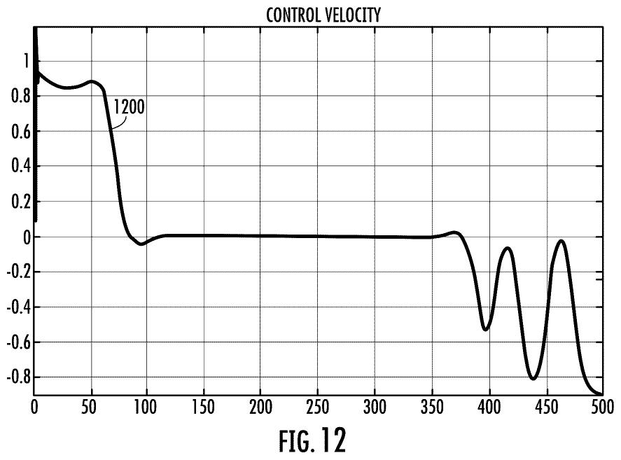

FIG. 12 shows the control velocity output for the entire path 1200. Note the sinusoidal forms at T=400 to 500 are not oscillations, but velocities induced by the stairsteps of the trajectory at that time.

The next step in the exemplar regulator and trajectory is to inject error in terms of overall drag and external applied wind forces. FIG. 13 shows the random wind generator. This is the wind component for the Z dimension only, so it represents updraft and downdraft wind conditions. While the wind direction and intensity are random, the intensity is limited to 5 m/s with a drag coefficient of 0.1. This means that a 5 m/S wind would have sufficient drag on the vehicle to alter its trajectory by 0.5 m/s. Changes in the wind variable occur every 5 seconds.

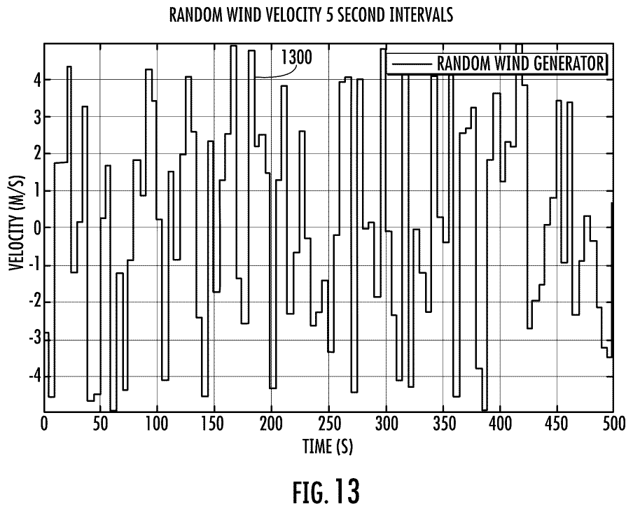

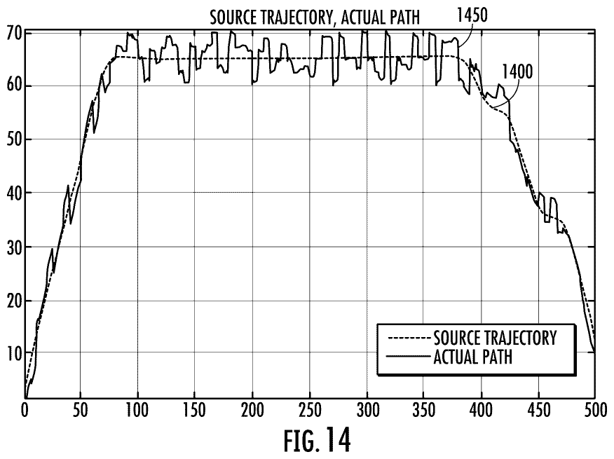

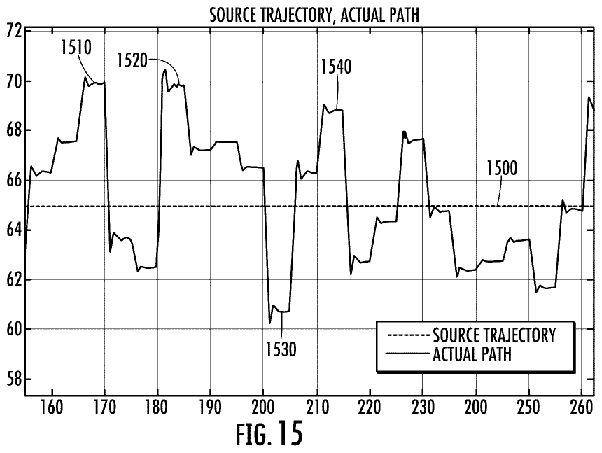

FIG. 14 depicts the source trajectory 1400 and actual path 1450 with the wind velocity added. It can be seen that the wind causes significant deviation from the source trajectory. In FIG. 15 a closer view of this deviation is shown with the dotted line as the source trajectory 1500 and the actual path 1510. An important observation of this effect is that while the deviations are significant, they indicate that an equilibrium state is reached between the wind force and the regulator's ability to compensate for it. This is evidenced by the plateaus in the path deviation at 165 seconds 1510, 180 seconds 1520, 200 seconds 1530, and 210 seconds 1540. The plateaus are also visible in the negative direction and, in effect, visible on each of the 5 second intervals. The equilibrium reached is proportional to the magnitude of the wind force.

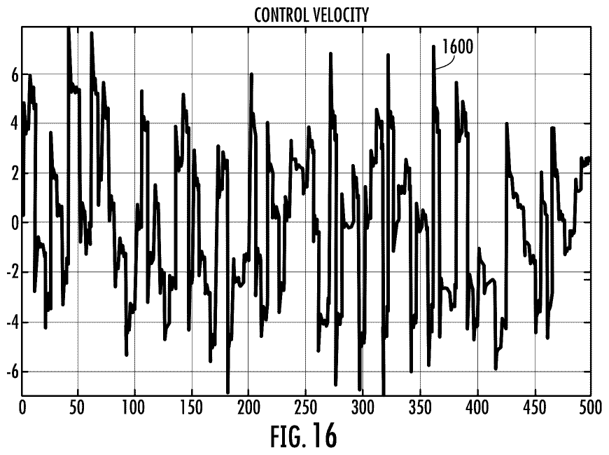

FIG. 16 depicts the control velocity 1600 necessary to counter the deviation caused by the wind. Note in this embodiment and example that velocities in excess of 6 m/s are required in the abrupt changes from one speed and direction to another, even though the average velocity of the vehicle is only 1 m/s.

This plateau effect is due to the fact that the control curve is derived as the exact fit of the requirements of a given one-second interval. Within that sample interval, transients in the location and velocity will be exactly countered in the next interval. Longer term disturbances, however, create this equilibrium effect as the first interval detects and corrects for the deviation in that interval. During this interval, however, the effect continues to exist, so it is also present in the next interval. For example, if a 5 m/s wind gust occurs and the drag coefficient is 0.1, the vehicle will drift off by 0.5 m. In the next time interval, an opposing force to compensate for the 0.5 m drift is added to the velocity, but at the same time the original 5 m/s wind still exists, so equilibrium is reached.

To counter this effect, a second error term is introduced. As shown previously in FIG. 2, it is possible to compute 113 114 the Z distance that would be traveled at the velocity set by the second calculation block 107 without the external disturbance. This is then compared 114 during each subsample of 0.1 seconds to the actual distance traveled with the disturbance 109 and the result is the value of this equilibrium point in meters/second. The system can then feed this error term directly into the next control signal to compensate for it, albeit one sub-sample behind the time. While the regulator can, within bounds, anticipate the velocity of the next sample time, it cannot anticipate transitory and external forces and so will respond one sample later.

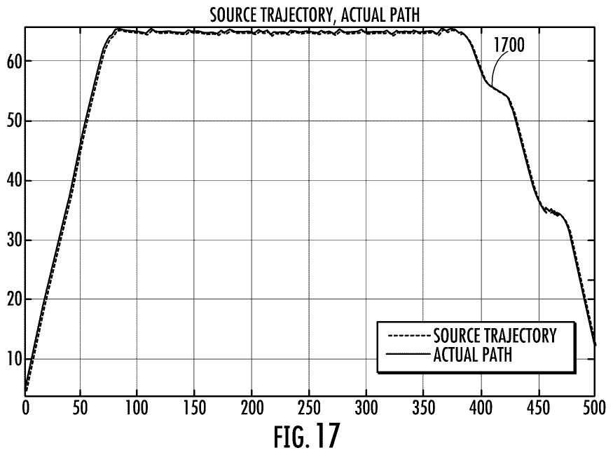

FIG. 17 depicts the source trajectory vs actual path 1700 with this second error term employed.

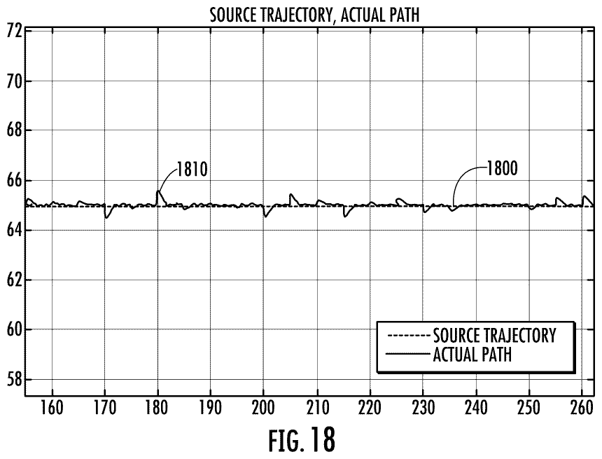

FIG. 18 shows a close-up view of the actual path 1800 at the same calibration as the previous trajectory error chart FIG. 15. This shows significant reduction and eventual elimination of the wind errors. The highest transients at 180 1810 and other areas still cause some error but they are eliminated in a few samples. In another embodiment, a tertiary or additional error terms could be added to further eliminate these errors, but eventually they become an exercise in diminishing returns. FIG. 19 shows the resultant error term 1900 and its relation to the wind plateaus is evident.

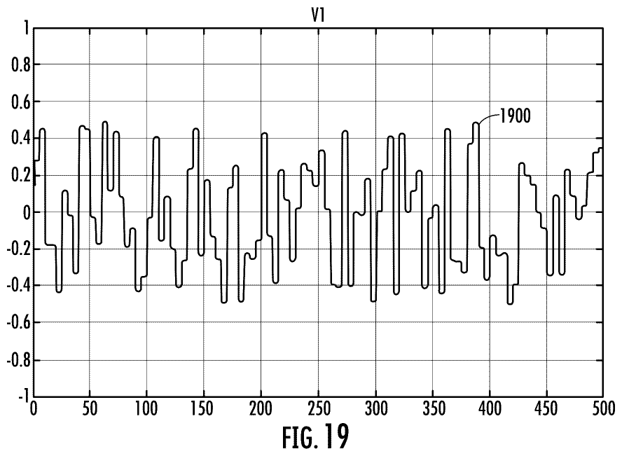

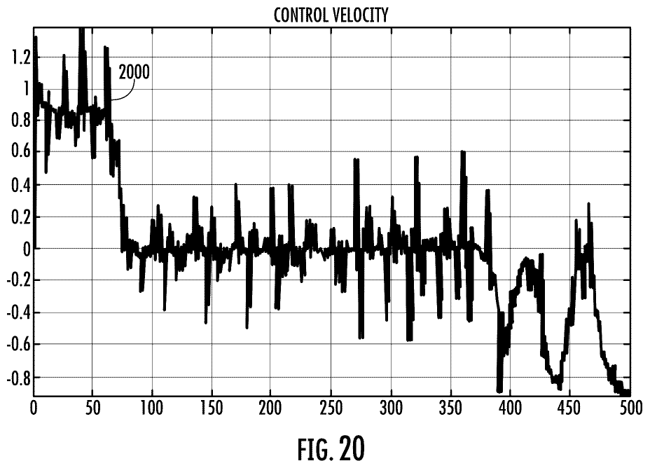

FIG. 20 shows the magnitude of the velocity component necessary to counteract the wind events. In another embodiment this value can be compared against the max and min velocity or power that can be achieved by the vehicle, actuator, or system and the output may be modified such that it does not exceed these limits. This may create additional error, which if tracked can be made up for at later sample times.

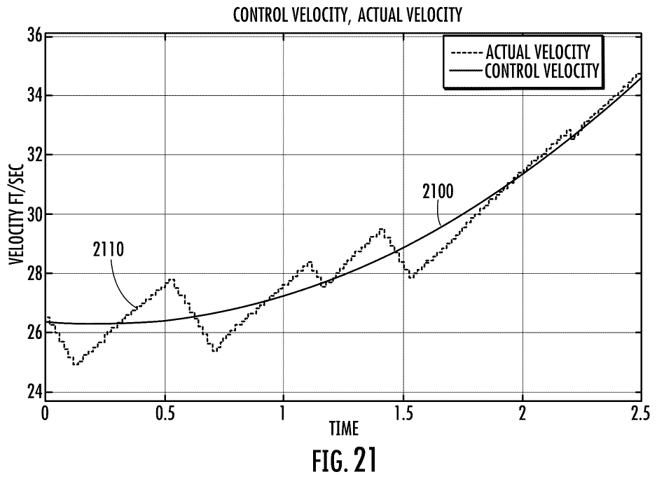

Similarly, FIG. 21 displays an alternative use of the algorithm, in that the polynomial of the output is utilized to compute a single parabola for the entire controlled trajectory of the vehicle. In this example the solid line 2100 is the optimal solution for traversing the given distance with the given starting and ending velocities. A secondary regulator may then control the system to keep it as close to this optimal regulation as possible. In this example the dotted line 2110 is the actual control signal, which has limited points where the system can exert control over the system. Some actual velocities are therefore higher than the optimal, and some lower. The error of the system is the total of the areas of these triangles, and the system utilizes an estimate of computing the velocity such that the higher and lower triangles nearly cancel each other out resulting in a very low overall error.

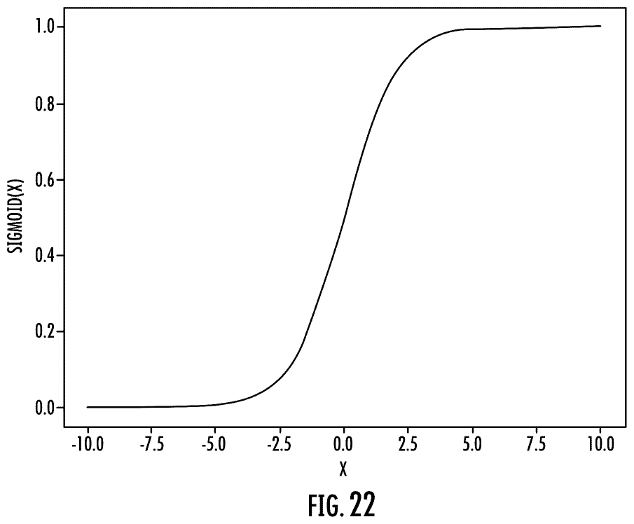

In another embodiment a polynomial or other mathematical expression is utilized in a similar manner to simultaneously solve for the distance and velocity change over time. For example, without limitation, a sigmoid function (FIG. 22) for matching two disjoint control signals is calculated to provide a smooth transition. This could occur in a robotics application where the control trajectory is suddenly switched, and the sigmoid provides a smooth transition for the position and velocity and the time may be a variable.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope and spirit of the invention. Further, different illustrative embodiments may provide different benefits as compared to other illustrative embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

The flowcharts and block diagrams described herein illustrate the architecture, functionality, and operation of possible implementations of systems, methods, and computer program products according to various illustrative embodiments. In this regard, each block in the flowcharts or block diagrams may represent a module, segment, or portion of code, which comprises one or more executable instructions for implementing the specified logical function or functions. It should also be noted that, in some alternative implementations, the functions noted in a block may occur out of the order noted in the figures. For example, the functions of two blocks shown in succession may be executed substantially concurrently, or the functions of the blocks may sometimes be executed in the reverse order, depending upon the functionality involved.

Implementation of the CPR may be performed in computer systems, hardware, or software, including but not limited to Von Neumann architecture machines, Field Programmable Gate Arrays, hardware accelerators, graphics accelerators, learning systems, AI processors and algorithms, optimization systems and architectures, custom or mass-produced silicon, simulators of any of the above, or cloud computing.

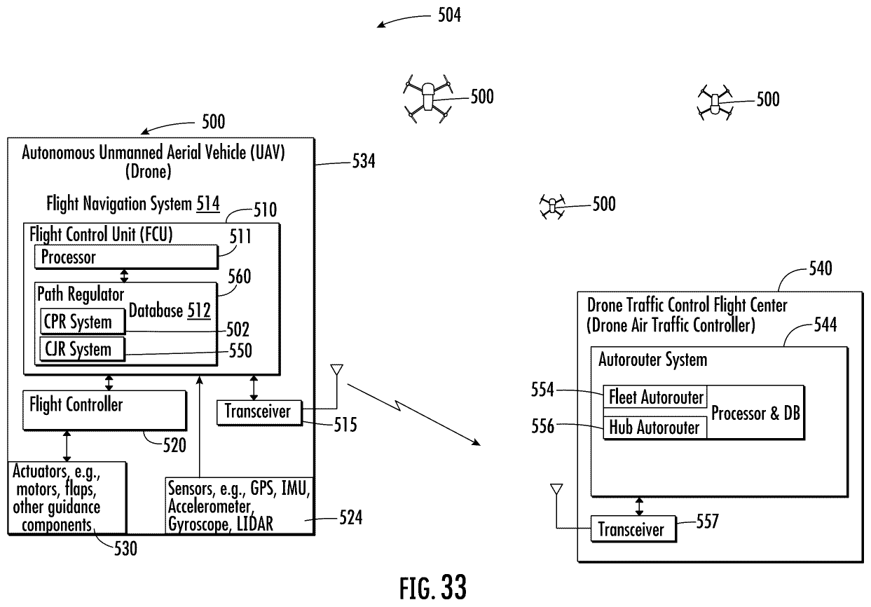

There now follows as shown in FIG. 33 a more detailed explanation of the Continuous Path Regulator (CPR) system 502 as described above when incorporated into a flight control unit (FCU) 510 of a drone 500, also referred to an autonomous, unmanned aerial vehicle (UAV), which operates within an autonomous unmanned aerial system shown generally at 504. The drone 500 includes a drone or flight navigation system 514. The FCU 510 may operate with a flight controller 520 in the drone that operates with sensors 524 and controls actuators 530, such as drone motors and flaps or other guidance components, all part of the drone navigation system 514. The FCU 510 may include a processor 511 coupled to a storage unit or database 512 for storing code, sensor data and other data. A transceiver 515 is operative with the Flight Control Unit 510 and may receive code updates or a flight trajectory as described below from a drone traffic control flight center 540. The flight trajectory may loaded and stored within the drone 500 using the transceiver 515 and internet connection or other links with wired or wireless delivery to the drone before the drone initiates flight.

As described generally above, given an existing continuous mathematical expression of a trajectory in space and time, a continuous mathematical expression may be a single line segment, parametric curve, or spline representing spatial coordinates that also have a corresponding velocity line segment, parametric curve or spline which, together with the spatial coordinates, can be used to interpolate the exact time that corresponds to a spatial position, or the exact spatial position which corresponds to any given time. “Any given time” is significant because it implies that the CPR system 502 is time independent. Most control systems for drones and similar aerial flight vehicles require that the sample time is monotonic, i.e., time between any two samples is always the same. This is not required with the CPR system 502 incorporated into the flight control unit 510.

Each expression may represent one dimension, such as Z, or it may represent two dimensions such as X and Y. Each mathematical expression should have a corresponding velocity expression, however. More than one dimension may refer to the same velocity expression. The continuous mathematical expression may also be made up of a series of simpler mathematical expressions such as a list of line segments, a sequential combination of line segments and curves, or a series of splines, as long as the endpoint of one segment is or can be construed to have exactly the same point and time coordinates where the transition occurs.

It may be necessary to project spatial coordinates such as triplets of X, Y, and Z into the time dimension such that each spatial dimension is an independent function of T, such as X=f(T), Y=f(T) and Z=f(T). The CPR system 502 may have more than three dimensions which may or may not be spatial dimensions, as long as all dimensions are represented as functions of T.

An equation may be derived from inputs of known current time, position, and velocity. Given the next desired time, which is not sample time dependent, that time may be used to determine via interpolation the next desired velocity and position for each spatial dimension. Given this set of data, a parametric curve of a parabola is constructed given two variables “a” and “b” from the equation aX**2+bX+C, where X is any of the spatial dimensions and C is known, and two equations, the velocity parabolic equation above and the integral of the velocity parabolic equation.

This is significant because the integral of the parabola is equal to the area under the parabolic curve. If the parabola represents velocity, the integral represents distance. The parabola provides the continuous mathematical expression which represents the exact solution to the velocity required in the next time period to keep the drone 500 on time, on position, and on velocity for each time period of the trajectory.

The CPR system 502 incorporates a procedure that may be optionally followed for greater accuracy before the trajectory is executed, such as where the trajectory is simulated, using the independent spatial dimensions as a function of time and simulating using the parabolic velocity equations derived from the simultaneous solution of velocity and position with respect to time. Projecting the dependent spatial dimensions into time to make them independent and using different velocity parabolas as necessary to keep them to the same endpoints in space and time produces some minor error effects in the position and/or velocity of the drone 500 at any given point of time between the endpoints. The larger the distance between endpoints, the greater this error can become.

The CPR system 502 may be used to determine how much error will occur over the execution of the entire trajectory, and that error can be compensated for in subsequent trajectories which will use this trajectory as deconfliction data. The drone 500 execution of the trajectory may result in some errors, but the CPR system 502 will know what those errors will be, which is important for precise deconfliction.

The flight control unit (FCU) 510 that processes the CPR algorithm in the drone 500 is given the trajectory data and a start time and executes the velocity parabolic equations to execute the trajectory in space and time. For each sample time of the navigation system 514 that indicates position and velocity, external forces may cause errors in the actual position and velocity of the drone 500. The CPR system 502 via drone sensors 524 in the flight vehicle and its processing may take the known position and velocity, with whatever errors may have occurred, and mathematically apply the exact correction via the velocity parabolic function calculation to return the vehicle to the correct time, velocity, and position at the end of the next sample time. Other forces may interfere with the execution of the next sample time, but the CPR system 502 provides a mechanism where the error in each sample is corrected preventing them from becoming additive over time.

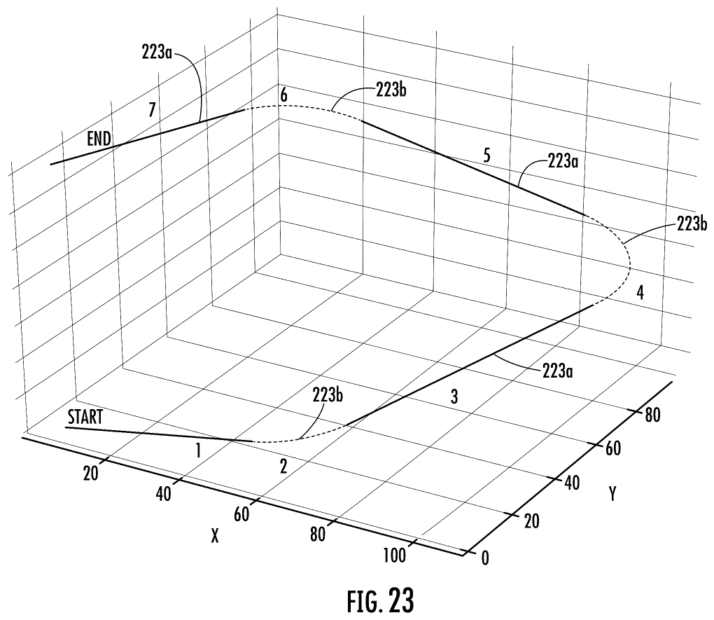

An example is now described with reference to FIG. 23 of the 4D trajectory and CPR system 502 operating for flight control in the drone 500 that includes the flight control unit 510 incorporating the CPR system with the flight controller 520 and the drone traffic control flight center 540 (FIG. 33) operating as a drone air traffic controller for management of a fleet of drones. The construction and execution of a Four-Dimensional (4D) trajectory is shown in FIG. 23. In this example, vehicle trajectories and the dimensions are interdependent. A graph can be expressed as Y=f(X), or Y is dependent on X. When altitude, i.e., the Z dimension, is added, it becomes less tractable and expanding that to four dimensions by adding a dependency on time T.

Referring to the graph shown in FIG. 23, the trajectory may begin from the lower left corner and continues through a series of straight lines shown at 223a and arcs shown at 223b. The arcs 223b are representative of either the boundary of an obstruction or the minimum turn radius of the drone 500. It is possible to place the particulars of this segment in as measurements, i.e., it is possible to specify the exact start point and end point in three dimensions as X, Y, Z, and set a start time and end time. This is possible in trajectory systems as a target or Waypoint. The drone flight control unit 510 will process the sensor 524 data and calculate flight vehicle motion to get to the Waypoint at the time specified.

The CPR system 502 incorporated into the processing of the drone 500 allows it to know where it is at any and every point in time. Because this is possible, previous autorouted trajectories in the airspace can be taken into account for future trajectories, and execution of fleet trajectories of flight vehicles as drones 500 at commercial scale becomes possible. Simulations of prior art multiple flight vehicles in complex environments using only sense-and-avoid methodologies have shown that the ability to predict the overall time of the flight vehicle in flight degrades exponentially when increasing the number of flight vehicles.

By knowing where the drones 500 are going to be and when, it is possible to solve this problem. The second facet of the 4D problem for the drones 500 is that the flight control unit 502 in the drone can only solve for velocity or position with respect to time. If the system controls velocity, it is not known what the actual position will be. If solving for position, it is not known what velocity will be used. Either way, this obviates the ability to know exactly where and when the drone will be between the start point and the Waypoint.

Some known drone systems may use control system techniques related to a Proportional, Integral, Derivative (PID) controller, which calculates the error between where the flight vehicle is and where it is supposed to be (the Waypoint) and modifies the controls over successive iteration loops to try to minimize the error, resulting in inefficiencies, undershoot, overshoot, and oscillations in the control loop. These all add to the total uncertainty of the prior art flight vehicle's velocity and position at any given time.

To solve this problem, the CPR system 502 incorporates a mathematical transform wherein dependent variables, i.e., X, Y, and Z that are all interdependent, may be transformed into independent variables by projecting them into another arbitrary dimension, A. Therefore, as the CPR system 502 projects the coordinates such that X=f(A), Y=f(A) and Z=f(A), then X, Y, and Z are now independent. Since A is arbitrary, and the CPR system 502 adds time T as the fourth dimensions, the transform becomes X=f(T) with the same for other variables.

The second step solves two simultaneous equations in order to specify the velocity between the start and end points such that the velocity is known at every point in time, and the position along the path is known for every point in time, and all flight parameters of velocity, position, and time are met simultaneously at the Waypoint.

For example, if the trajectory specifies a start point, velocity, and time, and an end point, velocity, and time, if the CPR system 502 attempts a linear solution to velocity, i.e., a straight line from Vstart to Vend, the position will not work out. Similarly, if the CPR system 502 solves the linear change in position, the velocity will not work out. If the CPR system 502 uses a second order equation such as a parabola for the velocity solution, however, the parabola can be expressed as V=aT**2+bT+c where ‘c’ is the initial velocity and T is time. Thus, only two variables have to be solved: a and b.

The parabola will span from Vstart to Vend. The area under the parabola as the integral of the parabola's equation is equal to the distance travelled. There are now two equations and two unknowns, therefore, the simultaneous solution to both velocity and distance at time T is solvable. The new equation does not just attempt to reach a workable solution over multiple iterations like the PID loop, but it provides an exact mathematical solution to getting to the Waypoint on time, on position, and on velocity with the exact position and velocity known at every point in T.

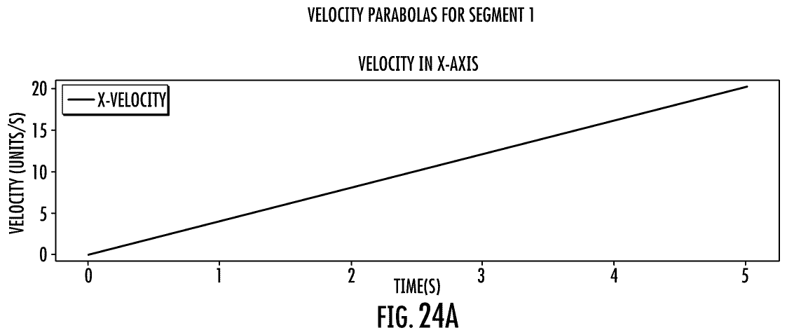

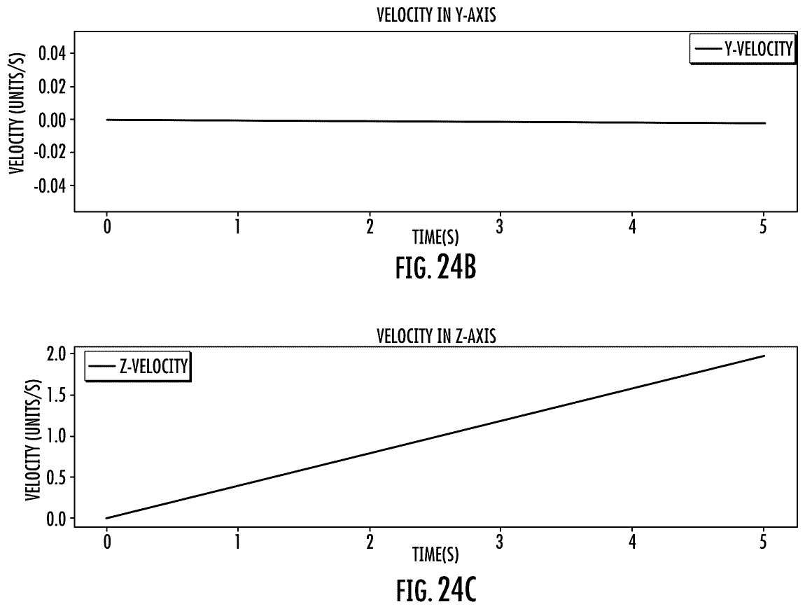

There is also a flight controller implementation operative with the flight vehicle's flight control unit. Given the trajectory defined by FIG. 23, then for each segment (1-7), it is possible to use this mathematical equation to determine the parabolic velocity curve for each dimension. This can be done independently on each dimension because of the transform into the T dimension. For example, the parabolas for the first segment will look like those shown in FIGS. 24A-24C showing the velocity versus time for the X, Y and Z axes.

The trajectory is constructed by the autorouter system 544, such as part of a drone traffic control flight center 540 and loaded into the flight control unit 510 operating with the flight controller 520. In this example, it is given a nominal horizontal velocity parameter of 20 m/s. This is the target velocity for X and Y. The nominal climb rate is given by the user as 2 m/s in this example. The trajectory therefore specifies that the first segment will accelerate from “0” at launch to 20 m/sec. Because the first segment is a straight line in X and is a constant 0 in Y, the X parabola simplifies to a line, which is to be expected. Z has a constant rate of climb over the entire trajectory.

The position of X, Y, and Z can be determined at any T from the equations of these graphs as lines or parabolas. Because Y has no change in distance, there is no Y velocity component yet in this example. It can easily be seen that the area under the X trajectory is 50 m, which is the exact distance travelled.

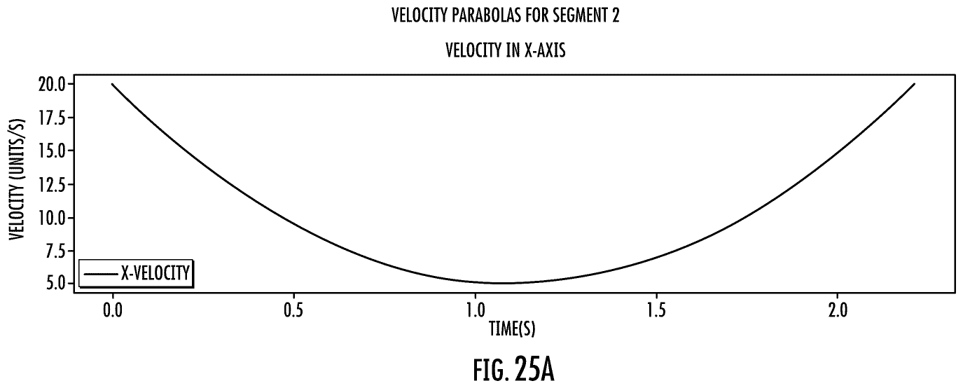

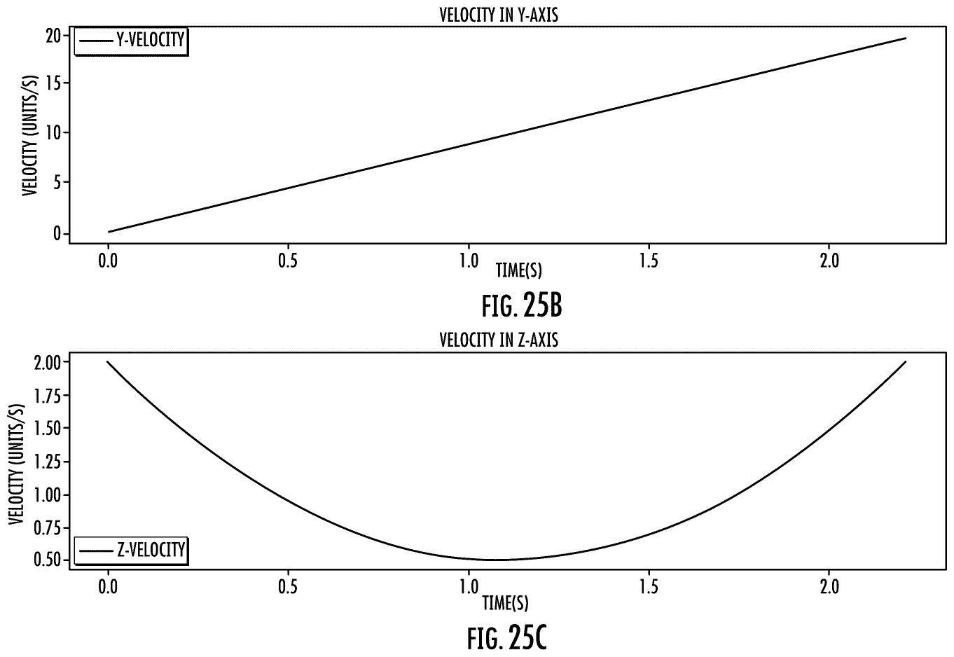

The second segment is an arc and shown in FIG. 25A-25C. In segment 2, there is now a change in Y distance for the drone 500, so it may now be accelerated to the target 20 m/sec. This determines the overall time for the segment in the autorouter system 544 generated flight plan loaded into the flight control unit 510 by the drone traffic control flight center 540. It may be loaded before takeoff via wireless or other means. As a result, X and Z will slow down slightly so that they will all be at the same time, velocity, and position required by the trajectory. Again, the area under each curve equals the distance travelled. In the first segment, the distance was a straight line. In this segment, the distance may be interpreted as the distance along the arc-length of the specified curve.

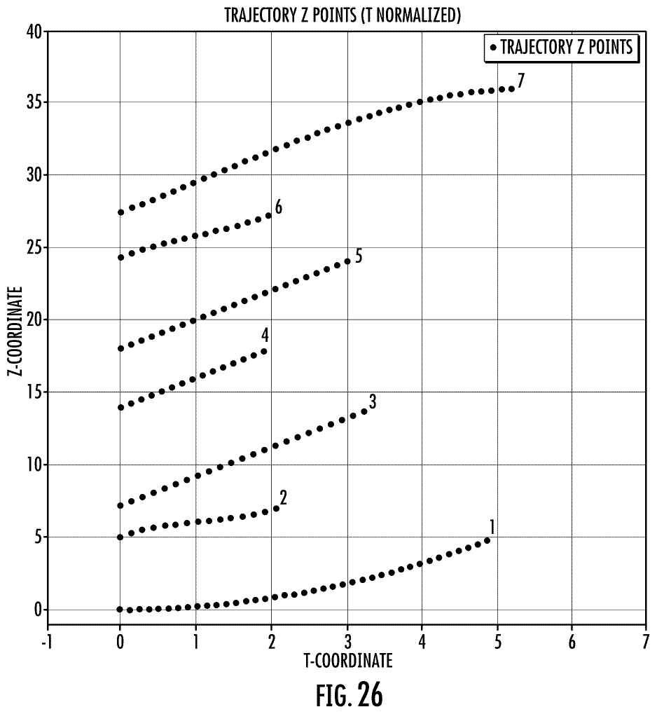

In the Z dimension, the altitude is linear. When linear dimensions are interpreted with a parabolic velocity, they may appear to have a somewhat sigmoid trajectory as shown in the graph of FIG. 26 as the Z-coordinate and T-coordinate. As illustrated in the graph of FIG. 26, the T span for each segment is numbered 1-7 and corresponding to the segments 1-7 in FIG. 23 and are normalized so each segment interpolation starts with T=0. The first segment shown at the bottom is accelerating from Vstart=0. The second segment shows the sigmoid position behavior when the velocity is slowed to match the other dimensions. The third, fourth, and fifth segments have a nominal climb rate. Segment six also shows a slight sigmoid. Segment seven at the top section shows the vertical climb rate dropping to zero as the trajectory reaches the endpoint.

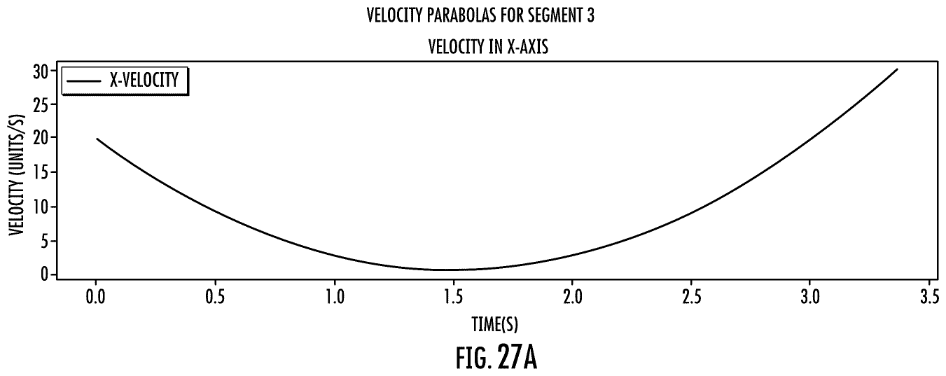

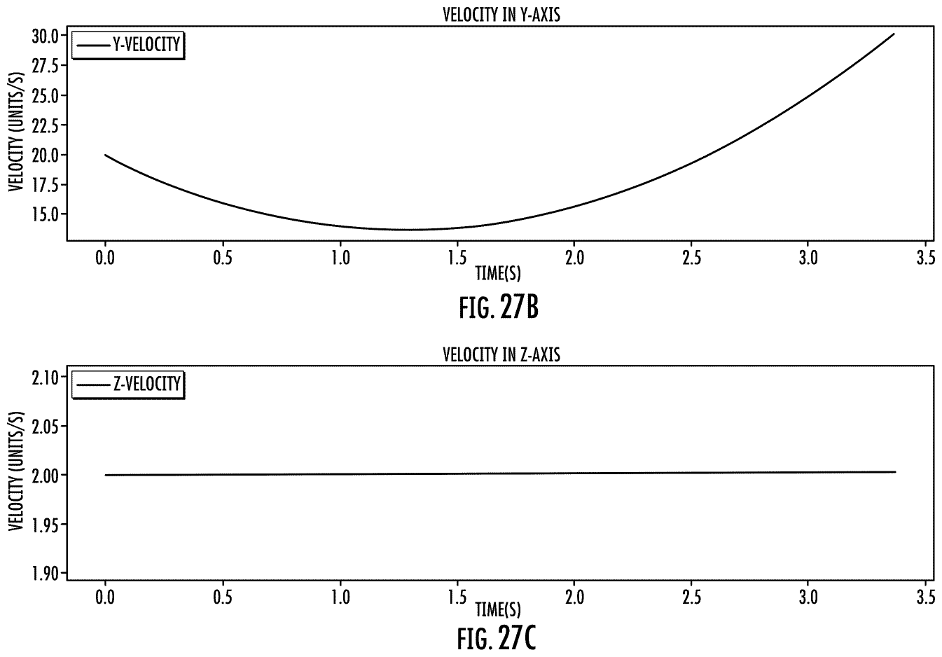

As illustrated, segment 3 is a vertical line with a slope in X and Y. The parabolas for this segment 3 are shown in FIGS. 27A-27C. The segments show an example of velocity changes. The trajectory was generated with a nominal horizontal velocity of 30 m/s. In X and Y corresponding to FIGS. 27A and 27B, both parabolas depict the velocity curve needed to meet the time specified as the Waypoint and end with a velocity of 30 m/s. “Z” maintains its nominal climb rate through the time period. The parabolas for the remaining segments are similar.

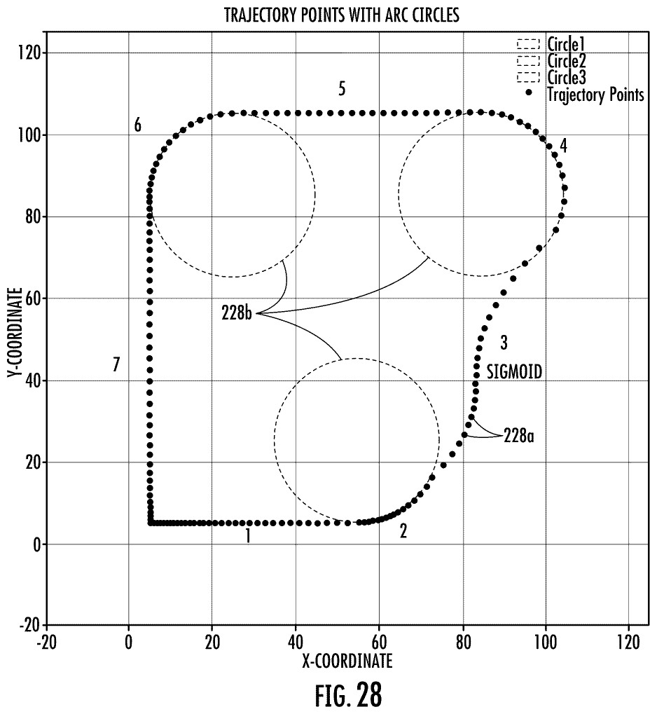

There is also a trajectory aspect for the drone 500. Given that the X, Y, and Z velocities and therefore positions are calculated for any T, the positions given for a time that is non-uniformly distributed is shown in the example of FIG. 28. The dots 228a illustrate the seven segments that are numbered and those dots indicate the position at T, and the dashed circles 228b are the given definitions for the arcs. Those dots 228a closer together indicate slower velocity. The trajectory for the drone 500 starts lower left at Z=0, then proceeds counterclockwise through the numbered zones 1-7 until it returns with 0 velocity in X, Y, and Z at the same point it started from, and then the drone 500 executes a vertical landing.

Segment 3 that is labeled as the sigmoid shows the sigmoid in the X dimension characteristic of slowing and speeding up of the drone 500 to match the required velocity and timing. This is acceptable even though this differs slightly from the original straight-line trajectory for the flight path proposed by the autorouter system 544 that developed the flight plan and implements the predetermined flight path. It is this line that will be checked against all other trajectories and obstructions in the autorouter system 544 at the drone traffic control flight center 540 before the drone 500 is released for flight. This final trajectory will be stored for future comparison to new lines as they are corrected.

It should be noted that the CPR system 502 operates at the drone 500 with the autorouter system 544 as part of the drone traffic control flight center 540 that generates the trajectory and transmits it to the drone, and includes an additional dimension ‘AL’ for the Avoidance Limit. This Avoidance Limit is an area or zone around the drones 500 at every point in time, within which the drone is allowed to make avoidance maneuvers, allows for errors induced by outside forces, and allows for slight trajectory deviations such as this. No other route may impinge on the AL envelope of another trajectory of another drone 500. This allows for the handling of unexpected and external errors in the trajectory without causing the entire trajectory to fail.

If all conditions were perfect, these trajectories for numerous as drones 500 could be flown without error. During flight any number of perturbations, environmental influences, and maneuvering can cause errors between the start point and Waypoint. The CPR system 502 in each drone 500 constantly corrects these deltas in all the drones for the fleet of drones.

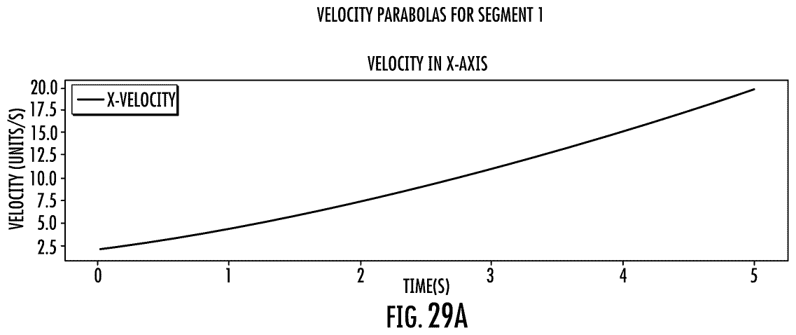

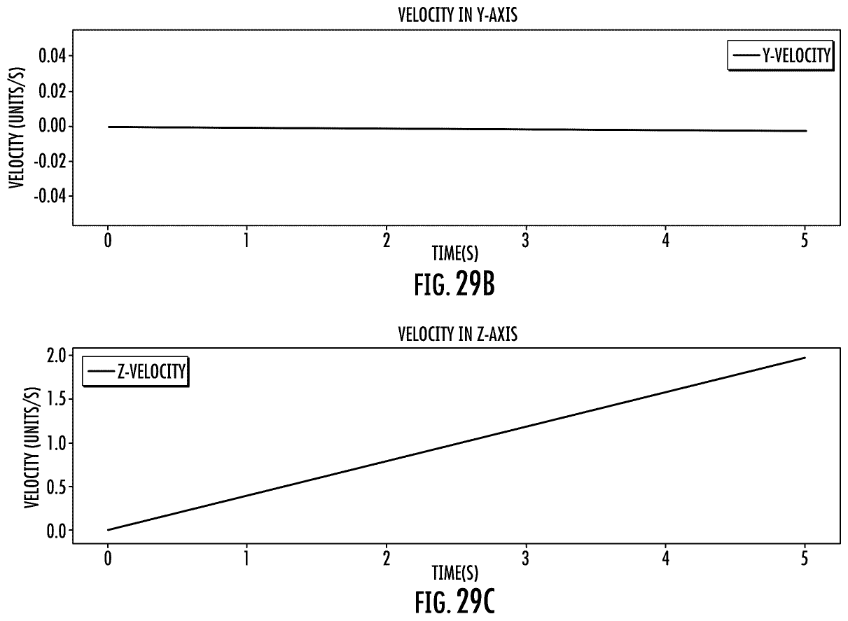

An example of this for a drone 500 is shown in the parabolas of FIGS. 29A-29C. In this example, the drone 500 experiences a force from the west, which increases its X velocity by 2 m/s and pushes it slightly in the +X direction. At the beginning of each segment, a new position and velocity fix is computed, and the position and velocities of the segment start parameters are updated. The parabolas are then updated to take these changes into account such that the drone 500 still reaches the next Waypoint at the prescribed time and stays within the Avoidance Limit. As can be seen in the X parabola, the velocity at T=0 is updated, and the parabola now begins at 2 m/s and curves slightly to compensate for the change.

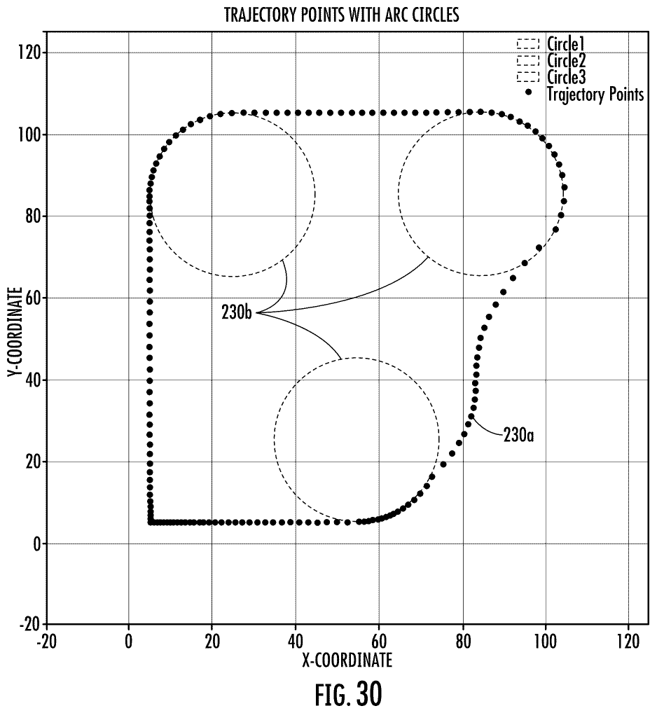

The slight change in starting position is shown in the example of FIG. 30, which is similar to the trajectory of FIG. 28, but with slight changes and showing the dots 230a and circles 230b. To minimize the error, the period between recalculations can be of any value, up to as fast as the flight vehicle can refresh its position and velocity fixes, and the timing can be inconsistent. Missing updates will allow for increased error but will not cause the trajectory to fail. The dots 230a at the start of the segment are now closer together, indicating the parabola is processed and the flight control unit 510 has instructed the flight controller 520 to slow the drone 500 to compensate for the increased speed and distance errors.

The data associated with a given segment may be organized generally as shown below in order to enhance processing of data at the flight control unit 510 of the drone 500 with its autorouter 544 generated flight plan received from the drone traffic control flight center 540. The autorouter system 544 is associated with one or more drones 500 to develop the flight plans for drone fleet management for deconfliction.

There now follows a description of a data organization.

### Data Organization

### Segment 1:

Start Point: PointTrajectory(x=5, y=5, z=0.0)
End Point: PointTrajectory(x=55, y=5, z=5.0)
Nominal horizontal velocity: 20.0
Nominal climb rate: 2.0
Is Arc: False
Is CCW: False
Center: PointTrajectory( )
Radius: 0
Segment Distance: 50.24937810560445
   Parabola for x-axis:
a: 0, b: 4.0, c: 0
distance_start: 0.0, distance_end: 50
velocity_start: 0.0, velocity_end: 20.0
time_start: 0.0, time_end: 5.0
   Parabola for y-axis:
a: 0.0, b: 0.0, c: 0.0
distance_start: 0.0, distance_end: 0
velocity_start: 0.0, velocity_end: 0.0
time_start: 0.0, time_end: 5.0
   Parabola for z-axis:
a: 0, b: 0.4, c: 0
distance_start: 0.0, distance_end: 5.0
velocity_start: 0.0, velocity_end: 2.0
time_start: 0.0, time_end: 5.0

The PointTrajectory structure may have any number of dimensions, to allow inclusion of the Avoidance Limit that extends around a drone 500 and any other facets of the drone, which can be expressed as a function of time.

There now follows an explanation via pseudocode description that outlines each step of the derivation to produce simultaneous solutions to velocity and distance and solve for “a” and “b” matrices for drone 500 trajectory regulation and control.

### Define Symbolic Variables:

X1=sym(‘X1’);
X0=sym(‘X0’);
V1=sym(‘V1’);
V0=sym(‘V0’);
T1=sym(‘T1’);
T0=sym(‘T0’);
t=sym(‘t’);
a=sym(‘a’);
b=sym(‘b’);
c=sym(‘c’);
d=sym(‘d’);
dv=(V1−V0);
dt=(T1−T0);
dx=(X1−X0);

### Define Velocity and Position Functions:

v=a*(t−T0)∧2+b*(t−T0)+c
v=c−b(T₀−t)+a(T₀−t)²
   Integrating velocity equation to get position equation:
x=int(v, t)+d
x=d=ct−a(T₀−t)³/3+b(T₀−t)³/2

### Solve for Initial Conditions:

V=@(T)subs(v, t, T);
X=@(T)subs(x, t, T);
   Solve for velocity equation initial condition:
cNew=solve(V(T0)==V0, c)
cNew=V₀
   Solve for position equation initial condition:
dNew=solve(X(T0)==X0, d)
dNew=X₀−T₀c
dNew=subs(dNew, c, cNew)
dNew=X₀−T₀V₀₊

### Apply Initial Conditions to Velocity & Position Equations:

v=subs(v, c, cNew)
v=V₀−b(T0−t)+a(T₀−t)²
x=subs(subs(x, c, cNew), d, dNew)
x=X₀−T₀V₀+V₀t−a(T₀−t)³/3+b(T₀−t)³/2
V=@(T)subs(v, t, T);
X=@(T)subs(x, t, T);
   Test X(T) for different values of T:
V(T0)
ans=V₀
X(T0)
ans=X₀
V(T1)
ans=V₀−b(T₀−t)+a(T₀−t)²
X(T1)
Ans=X₀−T₀V₀+T₁V₀−a(T₀−T₁)³/3+b(T₀−T₁)³/2

Solve for a & b Coefficients: Since the values of T0, T1, X0, X1, V0, V1 are known, the CPR system 502 creates two equations of a line of the form (A*a+B*b=C). These can be arranged as a matrix equation of the form A*x=y.

[A, y]=equationsToMatrix([V(T1)==V1; X(T1)==X1], [a, b])

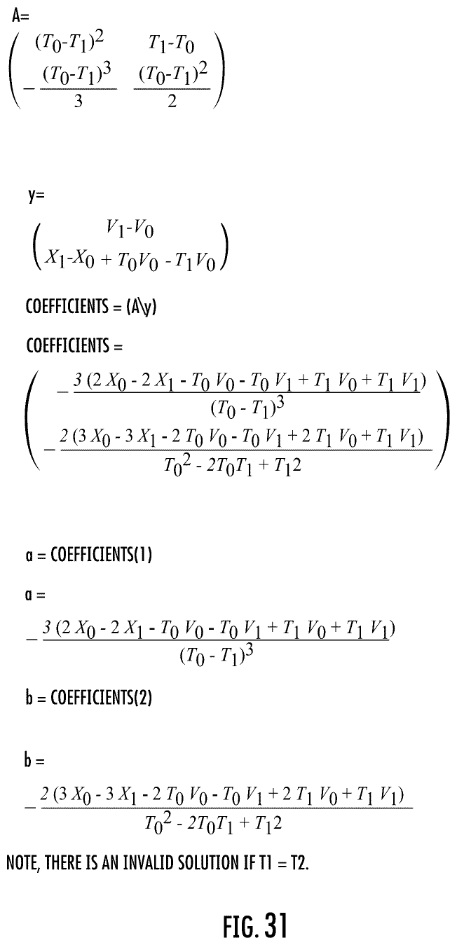

FIG. 31 shows the matrix equations A and y and the A/y coefficients together with a and b coefficients.

Referring again to the block diagram of FIG. 2 generally described above, explanation of the Continuous Path Regulator (CPR) system 502 that is incorporated into the flight control unit 510 are now described. The first and second computation blocks 104,107 as processors operate together for State & Targets and ingest X0/Y0/Z0/V0/T0 and the next target X1/Y1/Z1/V1/T1 (plus constraints Vmax/Amax/Jmax if present). The CPR system 502 computes ΔX and boundary terms. It then has a closed form CPR solve function and will solve V(t)=a t∧2+b t+c on [T0,T1] s.t. V(T0)=V0, V(T1)=V1, and ∫V(t) dt=ΔX. This yields unique (a, b, c), eliminating, tuning/iteration.

The processor functions shown as the first and second computation blocks 104,107 then operate to have continuity across segments and construct per interval solutions with velocity/acceleration continuity, and optional jerk bounds across junctions to avoid oscillation. The CPR system 502 then performs subsample and scheduling via a loop function to interpolate/reconstruct commands at higher rate (e.g., 50-100 Hz) with polynomial/cosine bump methods, preserving C¹/C² continuity and aligning clock ticks to the flight control unit 510 (FCU) timing as rate transition and triggered/enabled subsystems that may be part of the flight control unit.

Next, time stamped velocity/position setpoints are delivered to the flight control unit 510. Inner attitude loops map these to relevant drone actuators 530 at high frequency for flight vehicle movement. The processors then have a disturbance correction and on the next CPR tick, recompute (a, b, c) from the measured state, inherently resetting any accumulated error even under a wind and load variation. There are limits and faults such that on actuator/estimator limits, the CPR system 502 adjusts subsequent interval demands while the loop function maintains smooth outputs to prevent shocks.

Another aspect is considered because many systems use X, Y, Z as dependent variables in describing the trajectory. Keeping the trajectory dimensions independent leads to slight deviations from the original path segments that were given at the start of the process. If there is a group of straight lines and added time they may be separated out as x=f(t). They may be executed for flight control. The CPR system 502 may alter the original trajectory to compensate for external forces, such as the wind as error terms in describing the difference between where and when the drone 500 is and where the drone is supposed to be.

The errors due to external or internal forces, such as a bent propeller blade on the drone 500, may be corrected, but this correction may be applied differently to each dimension and there may be different error terms. This is recognizable as a slight sigmoid as third-degree errors in the final trajectory path. When going from velocity 0 (V0) to V1, and from position (X0) to position X1, many prior art drones have their own type of system to estimate a trade-off, but there is an exact solution, which the CPR system 502 solves.

It is possible to: 1) create a trajectory out of segments, e.g., points, lines, polynomials, splines, etc., and 2) use velocity, velocity plus acceleration limits, or velocity plus acceleration plus jerk, etc., and use five polynomial terms to apply time to each segment of the trajectory within the limits of the drone 500. These segments should be continuous at the crossings in order to prevent higher order effects and drone 500 oscillation. For example, if velocity is changing and acceleration is not controlled, such as zero or a constant at the crossing point, then there can be unwanted jerk in the next derivative of the dimension and oscillation. It is possible to convert X, Y, Z, T to x=f(t) etc. using cosine bump, etc. and in the drone 500, convert the x=f(t) and other dimensions into the optimal polynomial, in this example parabola, for the velocity value to be fed into the flight controller 520 that controls drone actuators 530, such as motors, flaps and other guidance components, to guarantee precise execution of the trajectory.

Reference is made again to FIG. 1-22 where further details are explained of the CPR system 502 as incorporated into the flight control unit 540. The four-dimensional autorouting via the flight control unit 510 for the drone 500 finds paths in space and time. The CPR system 502 operating in the flight control unit 510 not only provides highly predictable paths for the drone 500 across complex, crowded areas, but also deconflicts all the drones in a correct-by-construction manner. The drone 500 can follow a complex high-accuracy flight plan. The CPR system 502 operates as a control algorithm that is implemented in the navigation system 514 to ensure that the drone 500 is on time, on velocity, and on position, and corrected in all three dimensions simultaneously for each step in the drone's navigation.

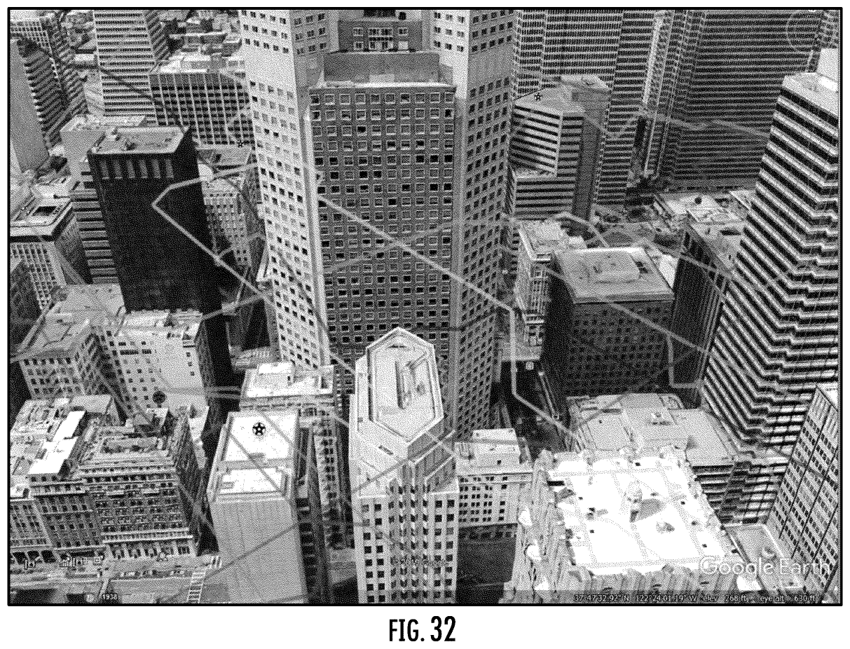

FIG. 32 is a schematic aerial view of a downtown metropolitan area with random flight plans implemented as a series of mathematical splines. Given a mathematical description for a continuous path, the drone's flight control unit 510 may calculate an exact mathematical solution to simultaneously correct for any errors and bring the drone back on time, on position, and on velocity at the end of the sample period. At the beginning of the sample period, the sensors 524 in the drone 500 provide the flight control unit 510 with the actual current location and velocity. The continuous path as established by the autorouter system 544 sent to the flight control unit 510 at a drone input provides the drone with a target location and velocity, which can be calculated for the end of the sample period.

FIG. 3 as explained before shows a continuous path in three (3) dimensions, with a constant velocity component added to create a path in four dimensions for space and time, starting from right and moving towards the left. It is also possible to specify the velocity component as a series of splines, line segments, and/or mathematical function because it is possible to interpolate the desired velocity and position of the path at any point in time. The path's dimensions are X, Y, Z, and T.

FIG. 4 depicts this path as a single graph of Z, i.e., the altitude, as a function of Time. The individual data points of the original path description as the small circles may be converted to a Piecewise Cubic Hermite Interpolated Polynomial (PCHIP) continuous spline. Within the drone 500, different sensor and computational limitations determine the “sample time” for the sensors 524 and other aspects of the navigation system 514, determine the minimum time it requires to determine where it is, decide what it is going to do next, and change the drone actuators 530, such as motor and control settings of the drone as necessary. That is usually, but not necessarily, set as the sample time of the CPR calculation.

It is known that the flight control unit 510 may incorporate processing where given a state of the drone's system, it is possible to measure the difference between its current state and the desired state, and “nudge” the flight controller 520 inputs for the actuators 530 and other guidance components in that direction until the result is achieved. These are not exact solutions to the problem, but over time, converge on a solution and may require hand tuning or modeling and are prone to undershoot, overshoot, and oscillation. The flight control unit 510 may incorporate control system solutions such as the Linear Quadratic Regulator (LQR) that produce more exact solutions. That type of processing, however, is computationally expensive and may be challenging to incorporate in limited systems such as with drones 500.

The CPR system 502 incorporated into the drone 500 and its flight control unit 510 is a multi-dimensional solution, and simultaneously solves for Time, Velocity, and Position. It is computationally fast and simple with two primary equations using add, subtract, multiply, and divide, and can be deployed in any number of problems simply and efficiently.

As shown in FIG. 4 also generally described above, there is shown the flight path of the altitude component of the trajectory, Z, and similarly independent CPR algorithms may be implemented for X and Y. For each sample time of flight data measured by sensors 524 and other components of the drone 500 and sent as flight data to the flight control unit 510, the drone status at this time is known as Z0 for the current altitude, V0 for the current vertical velocity component, and T0 for the current time. The next state of the drone 500 is derived from the known path description and is denoted as Z1 as the altitude the drone desires to reach at the end of the sample time, with V1 as the vertical velocity the drone desires to reach at the end of the sample time, and T1 as the next time. T1−T0 equals the sample time.

FIG. 1 as generally described above shows the variables in that simplified example. The horizontal axis on both graphs is Time. The vertical dotted lines across both diagrams help in aligning time between them. In the top diagram, the path of the vertical dimension Z is shown. In this time sample (T0 to T1), Z0 and Z1 are shown and it can be seen that Z1 is less than Z0, so the drone is descending. It can also be seen that compared to the path, Z0 is a little ahead of time, and thus, the drone velocity has been too high and the drone is ahead of schedule.

The second diagram of FIG. 1 is the Z velocity component of the same path. V0 is the currently measured velocity value and V1 is the desired velocity at T1. The CPR system 502 operating at the flight control unit 510 operates at this point and the straight line between V0 and V1 is the more direct path that the drone may fly to hit V1 at T1. The area under the V0 to V1 curve is equal to the distance traveled, Z0 to Z1. If a straight line path is executed, the distance travelled would be greater. As the drone 500 is already ahead of schedule at Z0, this would make the error in Z altitude even worse. To solve this problem, the velocity from V0 to V1 should be a parabola as accomplished with the CPR system 502 in the flight data unit 510 and this allows the drone 500 to shave off enough speed to correct for the error at Z0 and then gain speed again to make it V1 at T1. The area under the curve equals the distance Z1. All three variables are solved in the one solution. It is evident that the parameters a, b, and c are established for the parabola that solves the distance, speed, and time so that the drone 500 tracks in all dimensions.

Referring now to FIG. 6 described generally above, the velocity is increasing, but the velocity is rising from an initial value of 0. The distance to be covered is 0.1 mile. The parabolic parameters for the result are shown at the top, and the sample time is one second. This graph of FIG. 6 is the first sample time of the flight path shown in FIG. 4. FIG. 7 shows the second sample time for the flight path. The velocity is still increasing, but now the distance covered has increased to 0.9 mile in the sample path.

FIG. 8 as generally described above shows the third second of the flight path. At this point, the drone 500 has reached a constant rate of climb and vertical velocity is decreasing. The time sample is still 1 second, but as shown, the parabola has inverted indicating the decrease in velocity.

FIG. 10 as generally described above shows the actual velocity path determined by the flight control unit 510 using the CPR system 502 for the first five seconds of flight, to follow the path given. In this implementation, the sample time is constant, and Z and V are variables specified by the given path. This equation is time-variant such that the sample time can also be changed on a cycle-by-cycle basis, allowing possibilities by varying time in the flight control unit 510 directs the flight controller 520. Also, in FIG. 10 it is evident that the desired velocity is the variable that is processed by the flight control unit 510, and in this case, each sample time for the parabolic equation is split into 10 subsample times to process the velocity setting at the flight control unit. This subsample rate can be faster or slower than the 10× clock as used.

In this implementation, velocity is sent to the flight control unit 510. It is possible and even probable that the flight control unit 510 operating the flight controller 520 as part of the drone navigation system 514 may not be able to achieve this velocity in the time given due to other system variables or simple inertia. The flight controller 520 also compensates for these types of static offset errors with the addition of at least one feedback error term to the fight control unit 510, which compares the velocity achieved at each subsample to the velocity required and adjusts the following velocity requests accordingly.

External variables such as wind can also affect the drone's ability to match the given flight path. In this case, random wind shear up to 5 m/sec was applied to a drone 500 model implemented in the flight control unit 510 such that the wind shear was present for five seconds and then shifted to another random velocity and direction. The functions described with reference to the block diagram of FIG. 2 show functions for the wind shear processing.

FIG. 13 as generally described before shows the comparison of the flight achieved in the simulation with static and dynamic perturbations applied, while FIG. 11 as generally described before shows the random wind shear applied to the drone. The graph in FIG. 18 as generally described before shows a blown-up portion of the actual flight path vs the given flight path allowing it to be seen in more detail. The slight deviations in altitude correspond to dramatic changes in the wind shear direction and velocity and correspond to the first subsample time period before the feedback error term began to compensate for the external force applied.

The CPR system 502 operating at the flight data unit 510 implements the CPR functionality and makes it possible to implement the drone navigation system 514 and is capable of following the predetermined flight plan with high accuracy in both space and time as established by the autorouter system 544 at the drone traffic control flight center 540. It should be noted, however, that the accuracy of the navigation is only as good as the accuracy of the current location as derived from onboard instruments and sensors 524 associated with the drone 500.

To determine location, each drone 500 may include its positioning and location sensors 524 as shown in the block diagram example of the drone of FIG. 33. Possible sensors 524 are now described. A GPS (Global Positioning System) with GPS Receivers may receive signals from multiple satellites to calculate its latitude, longitude, and altitude. The accuracy is within a few meters for standard GPS, but not always pinpoint.

IMUs (Inertial Measurement Units) may include components such as accelerometers that measure acceleration and gyroscopes that measure rotation. These drone sensor components 524 provide high-frequency data on the drone's movement and orientation, such as the pitch, roll, yaw for stabilization and dead reckoning by estimating position from motion. The drone 500 may include optical flow sensors, which are similar to a sensor on a computer mouse, to detect patterns and changes on the ground and estimate how far and fast the drone has moved relative to its takeoff point, which is functionally beneficial for more confined environments such as indoors or among crowded obstacles such as buildings as shown in FIG. 32.

The drone 500 may include LiDAR (Light Detection and Ranging) that emits laser pulses to measure distances to objects, creating detailed 3D maps for obstacle avoidance and precise navigation, especially indoors or in low light. The drone 500 may also include RTK (Real-Time Kinematic) GPS that uses ground-based correction signals for centimeter-level accuracy, and aid in surveying and mapping for better resolution and guidance. A compass/magnetometer may be employed to detect Earth's magnetic field and determine heading to determine a path direction as north. That type of drone sensor 524 may require calibration for accuracy.

The drone 500 may incorporate drone sensor data fusion to combine data from multiple drone sensors 524 to create a single, more accurate, reliable, and comprehensive understanding of the environment than any single sensor could achieve alone. Drone sensor fusion may involve several stages and leverage both hardware and sophisticated algorithms that include data collection where various onboard drone sensors 524 such as the cameras, LiDAR, GPS, IMUs, and other sensors that may be included in the drone may continuously collect raw data about the drone's position, orientation and surroundings.

Collected data may be accurately time-stamped and synchronized to ensure consistency across different drone sensors 524, which aids in real-time processing. Data processing and filtering may occur with raw data pre-processed to clean it, filter out noise or errors, and extract meaningful features such as edges and motion vectors. Data integration may include fusion algorithms that may incorporate advanced algorithms and Kalman filters, particle filters, or deep learning models, that merge the processed data streams into a unified environmental model. The algorithms may dynamically weigh each sensor input based on its current reliability or noise levels.

The flight control unit 510 then engages in decision making where the fused, high-confidence data is then used by the drone's flight controller 520 to make informed real-time decisions for obstacle avoidance, drone navigation, and path planning. A feedback loop may occur where the flight control unit 510 continuously collects new data and feeds it back into the process, allowing the drone 500 to adapt to dynamic changes in its environment.

As noted before, the drone 500 may employ various sensors 524 whose data is fused to enhance situational awareness as described before such as the Inertial Measurement Units (IMUs) that combine data from gyroscopes used for orientation, accelerometers for linear motion, and the magnetometers for heading to track movement and orientation. The Global Navigation Satellite Systems (GNSS/GPS) may provide precise and more accurate geolocation data, correcting the drift that IMUs experience over time. The LiDAR (Light Detection and Ranging) system may use lasers to measure distances and create detailed 3D maps as point clouds for the surroundings. Cameras such as electro-optical and infrared cameras may provide visual information as color, texture, and object identification, which can be used for object recognition and environmental mapping, even in low-light conditions, especially with infrared. A Radar (Radio Detection and Ranging) system may detect distant and fast-moving objects, especially in poor weather such as fog and rain, where cameras or LiDAR may struggle.

The sensor fusion for drone sensor data enhances drone autonomy and safety because it enhances accuracy by cross-referencing multiple data streams. Data fusion reduces the errors and uncertainties inherent in individual drone sensors 524. Data fusion increases reliability and redundancy because if one drone sensor 524 fails or its performance is degraded by environmental conditions e.g., a camera in fog or GPS in a tunnel or around crowded buildings in a downtown environment such as in FIG. 32, other drone sensors can compensate, ensuring system stability. It also provides a holistic view since each drone sensor 524 captures a different aspect of the environment. Fusing the data from the drone sensors 524 helps create a complete operational picture, enabling more complex tasks like simultaneous localization and mapping (SLAM).

The sensor fusion process may operate through a continuous loop of data processing. The drone sensors 524 may capture the raw environmental data that may include images, distances, motion, velocity, acceleration, pitch, yaw, and other factors. The sensor data is precisely time-stamped and spatially aligned such that the data from the camera and any acoustic sensors or other data from drone sensors refer to the same moment and location. The raw data signals may be cleaned and filtered to remove noise or outliers and advanced mathematical models may merge the data streams using Kalman filters that predict the drone's next state and corrects it using new drone sensor 524 measurements and particle filters used for more complex, non-linear environments with deep learning such as CNN and RNN.

There may be common sensor pairings such as the GPS and IMU where the GPS provides absolute position but updates it slowly, and the IMU tracks rapid movements but drifts. The fusion process for drone sensor data may use GPS data to correct IMU drift and the IMU may fill the gaps between GPS signals. The LiDAR and a camera may be used together where the LiDAR provides precise 3D distance measurements, while cameras add color and texture and fusing them allows a drone 500 to see an object and accurately classify in its distance as an obstacle. The radar may detect objects through clouds or smoke, while the electro-optical/infrared may provide visual confirmation.

As shown in the block diagram example the drone 500 of FIG. 33, the drone may include different components, including the frame or chassis corresponding to the body 534 of the drone 500 and include arms that support actuators such as drone motors and attach to the body. There is a trade-off between the longer arms that offer greater stability and the shorter arms that allow for better maneuverability. The drone body 534 may be formed as a lightweight, durable material such as carbon fiber, aluminum or engineered plastics to maximize flight efficiency. The drone motors may be brushless DC motors that offer high efficiency and durability. Any propellers may be air foil-shaped blades that create lift and thrust and use high-pitch props for maneuverability or longer props for heavier payloads.

Electronic circuits include controllers that regulate drone actuators 530 such as motor speed based on the flight controller signals instructed by the flight control unit 510 and convert DC power to three-phase AC power in an example. The flight control unit 510 operates with the flight controller 520 that receives the commands and directs the actuators to maintain stability and change directions or speed. The IMU that includes gyroscopes for orientation and accelerometers for speed control may provide six or nine degrees of freedom movement tracking. The GPS or GNSS module may provide high-precision geolocation data for autonomous Waypoint navigation and return-to-home (RTH) safety features.

An altimeter/barometer may measure atmospheric pressure and determine and hold precise altitude. Usually lithium-polymer or high voltage batteries are used and a transmitter and receiver as a transceiver system may be incorporated for the RS link such as 2.4 GHz or 5.8 GHz between the ground control station as the drone traffic control flight center and the drone and transmit by the autorouter system at the drone traffic control center the flight plans with Waypoints for multiple drones. The drone may include a gimbal as a motorized three-axis stabilization system that works with a platform that maintains cameras or sensors level regardless of drone movement.

### Drone Fleet Orchestration Using the CPR System at Each Drone and Autorouter Systems at Drone Traffic Control Flight Center

Many prior art drone programs fail to scale because they cannot launch and land enough drones per pad per hour to bring cost per drone down to a viable level. The bottleneck is not airframe design, battery chemistry, pad planning, or even regulation. The true constraint often is predictable concurrency for the ability to choreograph launches, landings, and en-route paths with precision across an entire fleet of drones.

Throughput depends on control, which often depends on a precision that cannot be achieved with legacy trajectory generators that optimize distance or velocity. Throughput requires the 4D trajectories flight paths that guarantee position, velocity, and time simultaneously and drones that are capable of adhering to them. Without this foundation, pad utilization collapses, buffers stack on buffers, overlapping trajectories create conflicts, departures bunch up, arrivals block departures, and the throughput stalls.

Many prior art drone programs fall short of their best mechanical throughput per pad. Many have barely reached the point where they can launch consistently, achieving only 10-20 launches per pad per hour, which is less than half their theoretical capacity and often maintain just 5-10 drones in the air at one time. Their focus is on shaving the timing buffers to raise launch rates and have not yet encountered the deeper delays caused by crossing trajectories, merge points, and corridor congestion.

Adding more drones or batteries does not fix the drone throughput issue, but may make the problem worse. The mathematics of encounter rates show that conflicts grow with the square of the fleet size. Delays increase proportionally with N as the number of drones, so even as more drones are added, overall throughput plateaus and then collapses. This is the “second wall” of drone delivery at the point where scaling the fleet of drones no longer increases capacity, but actively reduces it.

Legacy drone control systems such as Proportional-Integral-Derivative (PID) loops, reactive autonomy, or route-by-route planners were not designed for this crowded drone environment. Those prior art drone control systems are reactive, not predictive. They optimize individual drone flights, not fleets of drones. In sparse skies this shortcoming is tolerable, but in dense urban airspace where hundreds of drones, such as delivery drones, must share pads, corridors, and landing windows, it becomes fatal. Idle pads, missed slots, and cascading delays wipe out revenue potential.

A central bottleneck is throughput for how many drone flights can safely launch and land per pad per hour. Throughput at its root is a control problem. By moving to predictive fleet level scheduling of drones 500 using the autorouter system 544 and exact trajectory adherence using the CPR system 502 in space and time for each drone, this problem is solved.

There are differences between legacy or prior art drone linear trajectory generators and the 4D deconflicted trajectories used by the current system having the CPR system 502 in each drone 500 and employing the autorouter system 544 to generate a drone trajectory for each drone in the fleet. After initial gains as the fleet size goes through 20 vehicles in the air up to about 40 vehicles in the air for a representative area of operations, reactive drone system self-interference increases by N-squared and throughput stalls. With 4D deconfliction of the current invention, however, throughput scales with drone fleet size.

The CPR system 502 and autorouter system 544 of the current invention include additional components that directly address this bottleneck through two drone level system aspects and two drone fleet level aspects of the autorouter system 544 that together transform drone operations from reactive control to more optimum performance. The drone level solution includes two subsystems incorporated in each drone 500. The first is the Continuous Path Regulator (CPR) system 502 as described before that is installed in the drone 500 as part of the drone navigation system 514 and operates in the flight control unit 510 and provides exact velocity parameters to the flight controller 520 that controls actuators 530 such as motors and other drone guidance systems for navigation. The CPR system 502 ensures each drone 500 remains precisely on position, velocity, and time throughout its trajectory.

The second drone level aspect is the Curve Junction Regulator (CJR) system shown at 550 that is included in each drone flight control unit 510 and operable with the flight controller 520 in the drone. The CJR system 550 operates as a high-speed nonlinear PID replacement that smooths transitions whenever a deviation is required, such as during drone avoidance maneuvers, mid-flight path changes, or takeoff/landing corrections. Together, these two regulators as the CPR system 502 and CJR system 550 guarantee exact adherence without oscillation or tuning over all phases of drone flight. The internal CPR and CJR systems 502,550 referred, cumulatively as the path regulator 560, operate internal to the drone at the flight control unit 510 to allow autonomous operation along a flight path that had been developed by the drone traffic control fight center 540 using its drone autorouter system 544, such as at a ground-based drone air traffic controller or other location.

The drone fleet level solution includes its autorouter system 544 that has two autorouter aspects to operate with the fleet of drones and a processor and storage, e.g., processing and database functions and associated components. A first aspect is a cost function driven fleet autorouter 554 and the second aspect is a hub autorouter 556. Unlike prior art “shortest path” algorithms, the fleet autorouter 554 as part of the autorouter system 544 selects the best overall route for the drone fleet, balancing safety, efficiency, trajectory deconfliction, and system throughput. The hub autorouter 556 as part of the autorouter system 544 manages takeoffs, landings, and corridor crossings, buffering and stacking drones like an air traffic control system, specifying takeoff and landing pads, and managing slower velocities near the ground, gaining speed as separation distance also increases. Cumulatively, these fleet and hub autorouters 554 may be referred to collectively as the autorouter system 544 and the flight trajectories may be downloaded or transmitted to drones via transceiver 557.

There are some prior art autorouters that may improve path precision, but they are valuable only if the drone itself can fly 4D paths with equal precision. In the current invention, the flight orchestrator as the autorouter system 544 and path regulator system 560 formed from the CPR system 502 and CJR system 550 ensure that every trajectory is deconflicted by construction from pad to pad. This architecture solves both layers of the concurrency problem.

At the drone level, unlike traditional controllers such as PID, MPC, or LQR as noted before, the Continuous Path Regulator (CPR) system 502 provides an exact mathematical solution to flight errors. There is no drift, no oscillation and endless tuning. Each drone 500 holds its assigned slot in both space and time. Replanning is only needed in rare, off-nominal situations. At the fleet level, the autorouter system 544 includes deterministic scheduling that guarantees the launches and recoveries of drones 500 occur at commercial cadence, with every trajectory deconflicted in advance, not adjusted reactively after conflicts appear. The result is scalable throughput, which is measured directly in launches and landings per pad per hour, and thus, operate as a fundamental economic driver of viable drone delivery. The 4D autorouter system 544 as the fleet and hub autorouters 554,556 enables throughput and dense area deconfliction.

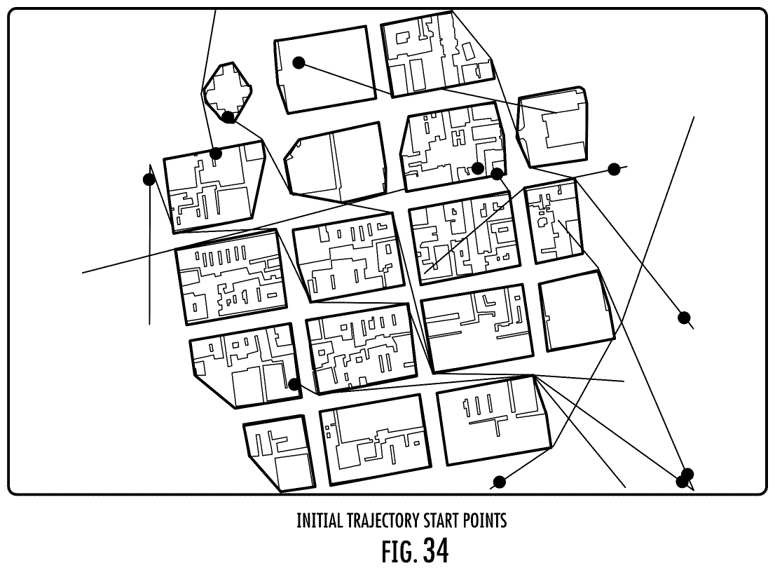

Another urban drone example is shown in the plan view of a section of a cityscape of FIG. 34, which illustrates how even small numbers of routes affect throughput. A 4×4 block area of downtown San Francisco, California is shown with the taller buildings in lighter shade and lower altitude buildings in darker shade. While only twelve drone routes as trajectories are shown, trajectory overlap errors have already begun to mount.

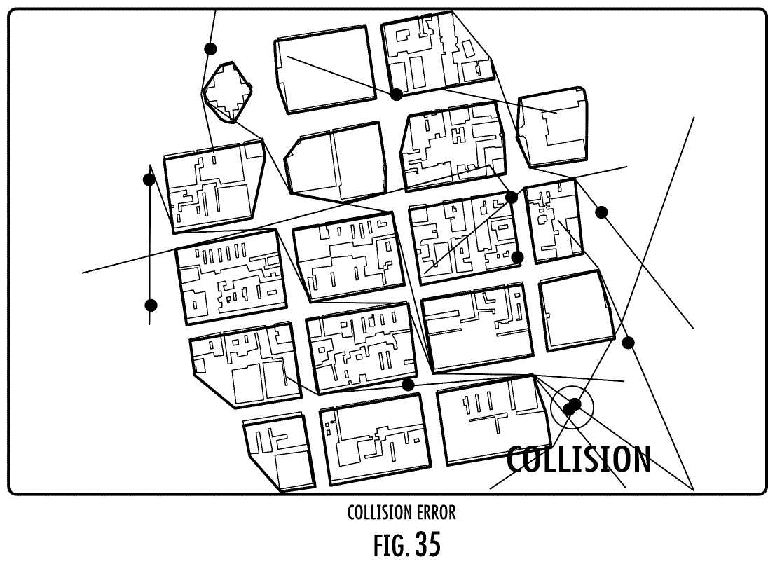

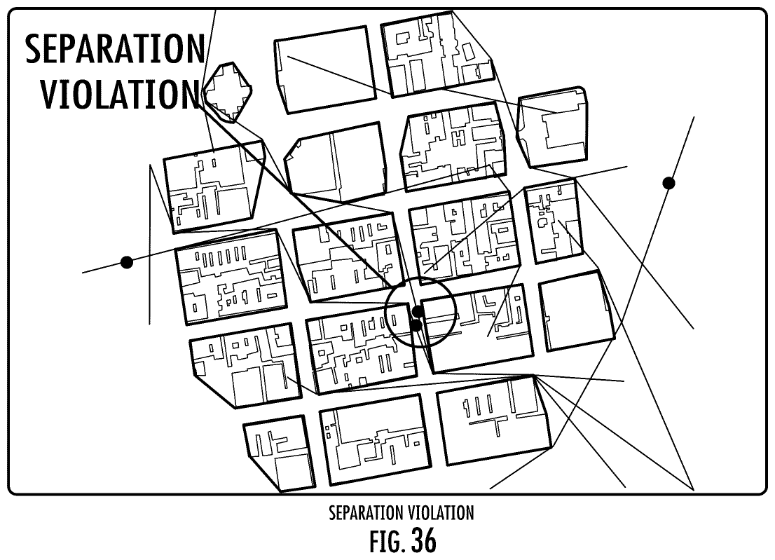

The starting points for the drones 500 are shown by the dots in FIG. 34 and the drone path, i.e., trajectories, are routed through the spaces between the buildings. Routed one at a time, however, the drones 500 create collision conditions or separation violations, such as shown in FIGS. 35 and 36, either by having two lines cross at the same point in time or by being coincident, i.e., both traversing the same corridor resulting in separation violation. Trajectory errors can be handled in multiple ways by changing the X, Y routing, changing the Z layer, and now, with 4D autorouting, and changing the Time dimension.

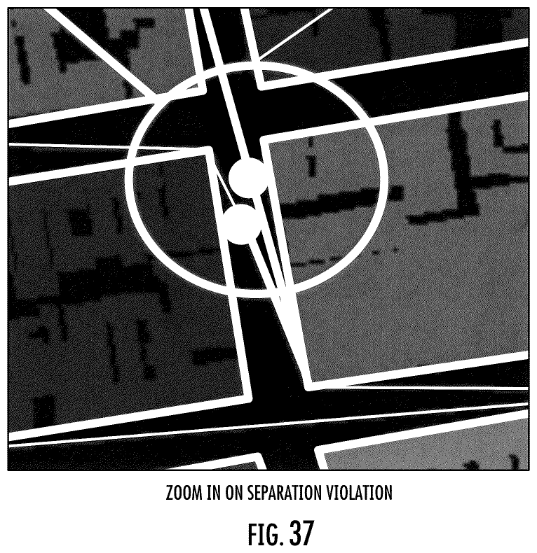

The trajectory line example of FIG. 38 shows how these errors are deconflicted by slight alteration of their starting times. The collision shown in FIG. 35 is avoided in the lower right corner of the trajectory line example in FIG. 38 by delaying one of the drones 500 by a few seconds. A close-up of the separation violation is shown in FIG. 37. None of these correction methodologies are available to prior art drone systems that expect each autonomous flight to find its way alone. In prior art drone navigation systems, once DAA (Detect And Avoid) detects the potential collision and requests a reroute, it can stop and wait for a new trajectory, but in that type of drone control system, all forward time knowledge in the system is lost and buffering is maximized.

Referring again to the trajectory line graph of FIG. 38, these same trajectories are shown, but with time deconfliction. The collision lower right is resolved by starting the other trajectory a little later. The separation violation in the center is resolved by measuring the amount of time the two tracks overlap, and delaying the start of the second trajectory by that time. This trajectory line graph highlights a key problem in autonomous flights without pre-planning. In the trajectory overlap case, the two drones are between tall buildings for a significant distance, and planning avoidance maneuvering in this space would be difficult. By pre-planning, the conflict does not occur. Two other drones in the lower right at approximately 90 seconds come close, but do not conflict before they diverge again.

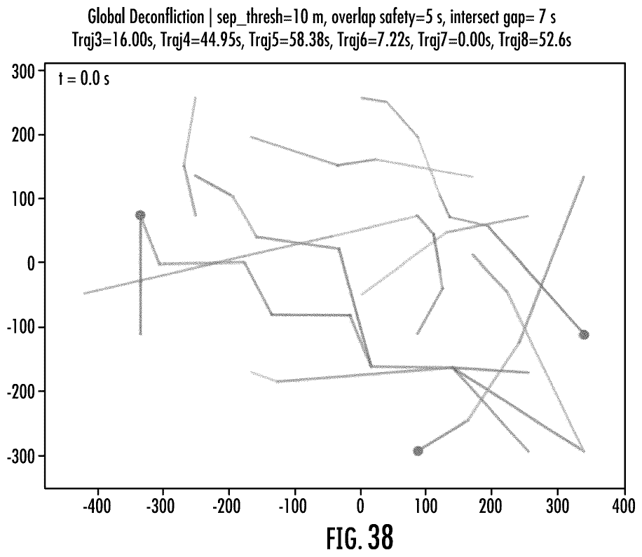

The autorouter systems 544 enable pad deconfliction for the drones 500 when a number of routes must take off and land in a small area, and determine how the drones can be controlled during the approach as shown in FIG. 39 using the autorouter system 544 for takeoff and landing pad configuration. In addition to flights across town, the autorouter system 544 creates full 4D trajectories from takeoff to landing, using an existing pad definitions and layout, which may be established by preplanning agents at the drone traffic control flight center 540, a package delivery service or freight service, medical delivery service, or other agent. Pads may be locked to only takeoff or only landing or used as both takeoff and landing using the autorouter system 544. Given the desired throughput and area geometry, the autorouter system 544 automatically creates a spatial graph of the area for 4D trajectory planning as shown in the cylindrical or drone flight graph of FIG. 40. The graph control points are seen as the circles identified in FIG. 39.

The hub autorouter 556 as a component of the drone autorouter system 544 establishes a preplanned flight path starting at the pad to which a respective drone 500 is initially assigned, and determines the pads to use for takeoff and landing, and the times through the drone flight network. As each drone 500 ascends, it is spread further apart and at greater altitude, safely allowing greater velocity as graphically shown in FIG. 40 with the expanding cone as the flight area for drones 500. The full trajectory for this drone flight, such as delivering a product, is the concatenation of the hub autorouter and fleet autorouter trajectories from one pad to another, or to another control Waypoint in the flight, such as switching to autonomous delivery mode once the drone has reached the designated delivery area. The drone 500 would then request a new route from a central drone controller at the drone traffic control flight center 544 that includes the deconflicted return flight and landing once the delivery is completed, such as using the autorouter system 544.

The imaginary lines between control points are not required to be straight lines since they can also be constructed from arcs or splines, and taking into consideration the specific requirements of drones 500. Both incoming and outgoing drone 500 flights may be considered simultaneously. In operation, a human or processor controlled controller at the drone traffic control flight center 540, which may be automated, specifies the locations of the pads, their characteristics, the horizontal and vertical area that is available, and the desired throughput. The autorouter system 544 calculates the layers and the number of rings per layer to be implemented in the flight plan and trajectory control strategy. The autorouter system 544 may also be used for taxiways, routes to maintenance hangers, storage locations, and similar items.

A bottleneck in some prior art drone autopilot systems is not the flight control itself as part of the drone flight computer, but a trajectory generator inside the drone flight computer. These more conventional prior art trajectory generators create a reference path that a low-level controller then “chases.” Many prior art autopilots use variations of polynomial trajectory generators, such as piecewise splines, minimum jerk, or minimum snap methods to connect Waypoints smoothly. While these prior art drone control techniques produce paths that are dynamically feasible and relatively easy to track, they do not guarantee time fidelity.

The result is predictable and some drones in the fleet fall behind or race ahead of their scheduled time slot and the flight controller has to operate the drone to sprint or lag to catch back up. Each correction introduces its own error, which cascades into overshoot, undershoot, or oscillation. Buffers have been added in some drone control systems to absorb these slips, but at scale they stack up and consume throughput.

Different known trajectory generator styles highlight the problem. For example, a conventional minimum jerk/snap system optimizes smoothness by minimizing higher derivatives of motion. This makes flight paths for the fleet or drones elegant and trackable, but timing constraints are treated as soft. Under wind or pad delays, a drone may drift off schedule, then must sprint to recover. Waypoint timed splines, on the other hand, attempt to enforce time stamps for drones at nodes, but still solve only approximately. Deviations between Waypoints accumulate, and with each reroute for wind, DAA, or sequencing the drone schedule drifts further. Another conventional system as autonomous drone replanners operate in fully autonomous modes and trajectories are recomputed frequently. Since timing alignment is not preserved, reroutes are constant and concurrency may break down completely.

This trajectory level imprecision from these known trajectory generator systems force flight controllers, such as PID, MPC, LQR, into reactive error chasing. PID loops must be hand-tuned for each drone platform and their loading and may compensate for errors introduced by the trajectory generator itself. MPC optimizes over a short horizon, providing local fixes but no global time coherence. LQR may optimize an entire path given a cost function, but is computationally heavy and still requires tuning. Although the inner loop errors may be minor, on the order of about 10 meters, the more destructive delays are those that occur when replanning or collision avoidance becomes necessary because of time imprecision.

These conventional trajectory generator approaches identified above are reactive and approximate and cannot guarantee that a drone will reach its assigned 4D slot in space and time, and thus, an entire fleet of drones may not remain synchronized. For that reason, many known current drone systems break down in high-density logistics because the concurrency collapses when each drone is “chasing” a moving target without taking all other drones into consideration.

In contrast, the CPR system 502 replaces the currently known trajectory generators that are part of these known conventional flight control systems identified above, and instead, employs a closed-form, tuneless regulator as the CPR system 502. Rather than producing approximate drone paths that require constant correction, the regulator as the CPR system 502 constructs the trajectory and the regulator rules for operating together. Drones 500 adhere exactly to their assigned 4D slots, eliminating drift, oscillation, and the need for buffer stacking. At the drone 500 fleet level with each drone having its own flight plan with specific Waypoints defined by the autorouter system 544, this deterministic adherence enables the orchestration of launches and recoveries at commercial cadence, unlocking scalable throughput.

The Continuous Path Regulator (CPR) system 502 operates where dependent variables are independent by projecting them into any arbitrary additional dimension. In flight, X, Y, and Z positions are not independent and they constrain each other. By projecting them into the time dimension, the fourth dimension to integrate as each spatial coordinate can be treated as its own function of T: X=f(T); Y=f(T); and Z=f(T).

Once expressed this way, the system of dependent variables that previously seemed unsolvable becomes tractable. In FIG. 6 described above, the flight control unit 510 of the drone 500 processes the trajectory and requests the inner loop to fly a path from position X0 to X1, changing velocity V0 to V1, in time T0 to T1. Current known drone trajectory managers either use a linear form, such as the dotted line, or some form of curve. Between two trajectory points, the Continuous Path Regulator (CPR) system 502 represents velocity as a parabola and V(T)=aT²+bT+c. This allows the CPR system 502 to interpolate the exact position of the drone 500 at any point in time.

Referring to FIG. 6 again as described above, the drone's movement is tracked between any two points in time, usually the sensor fused fixes of the GPS, IMU, and other position drone sensors 524. This graph represents the first second after takeoff. The trajectory specifies a distance of 0.1 mile in altitude, a starting velocity of zero (0), and an ending velocity of 0.09 m/s. In the general case, V0 is the measured current velocity and X0 is the current measured position in any dimension. In any real system, wind or other external forces and any kind of internal fault such as a worn propeller will cause error. That error is expressed as V0 and X0 not being on the point and velocity expected by the trajectory. With a tailwind, V0 and X0 might be higher and further than expected. The Continuous Path Regulator system 502 does not nudge the error towards a setpoint as accomplished with older control algorithms, but finds the exact solution to get the drone back on track.

Past issues for known drone control systems concerned how to calculate what happens between T0 and T1. Many conventional known flight controllers would attempt to execute the dotted straight line to hit V1 or try to reach position X1. The existing, conventional flight controller could not do both. The use of a parabola permits a solution. A parabola has the two variables noted above as “a” and “b” and there is one equation with the parabola, but there are two variables.

The CPR system 502 processes data such that the area under the parabolic curve equals the distance, and thus, provides two equations, i.e., the parabola and the integral of the parabolic equation. This turns the simultaneous requirements of distance, time, and velocity into two equations with two unknowns as a closed-form solution rather than an approximation and is solvable.

Unlike PID or a one-size-fits-all currently known drone trajectory estimations, the Continuous Path Regulator (CPR) system 502 solves the underlying problem directly. Each control cycle for the flight control unit 510 generates a new parabola that guarantees convergence to the correct position, velocity and time. External disturbances such as wind or drag are naturally absorbed because the next cycle recomputes a new parabola based on the current state and errors do not accumulate.

The result is a drone navigation system 514 that incorporates the CPR system 502 that is exact, deterministic, and tuneless. It does not matter whether the drone 500 is heavily loaded, buffeted by crosswinds, or subject to sensor noise because the Continuous Path Regulator system 502 ensures that at the end of each interval, the drone 500 is precisely where it should be, moving at the correct speed and exactly on schedule.

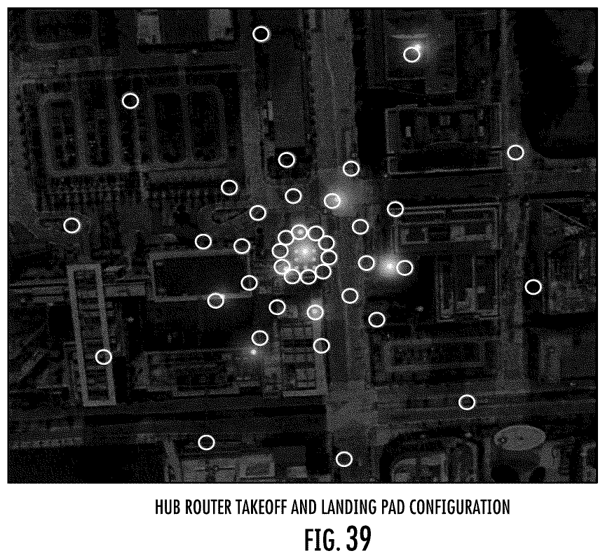

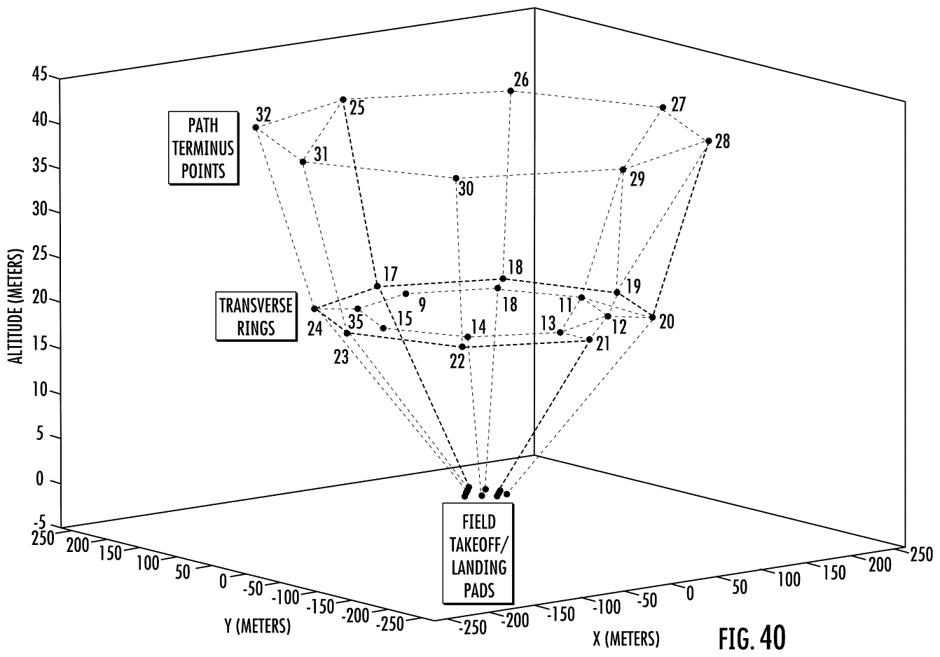

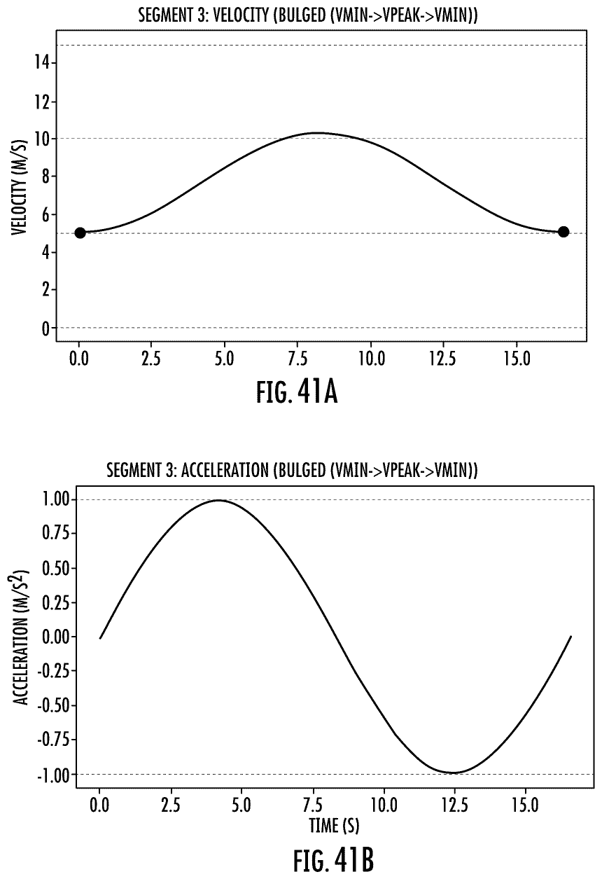

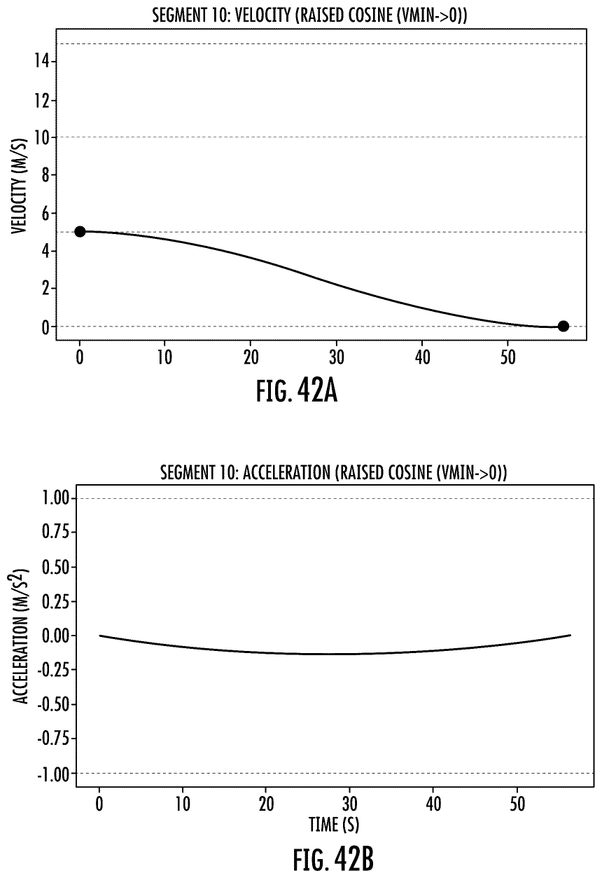

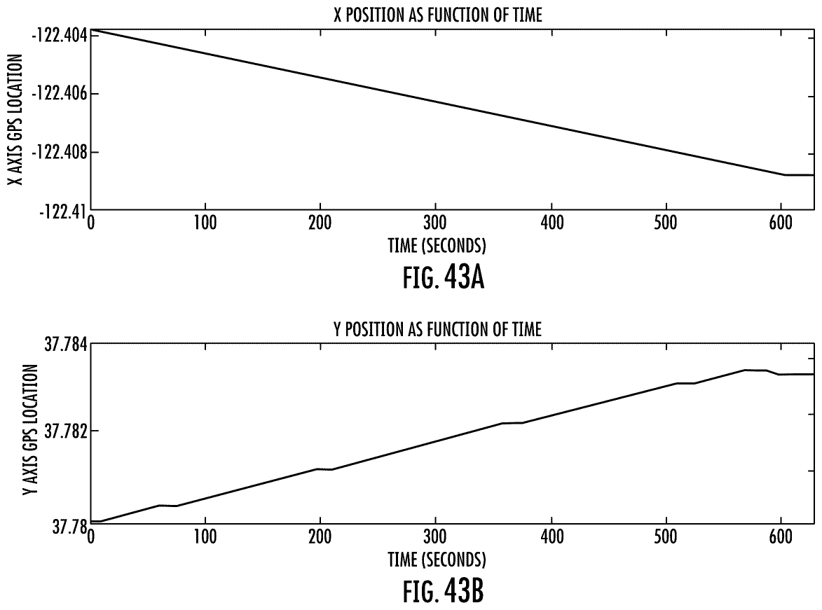

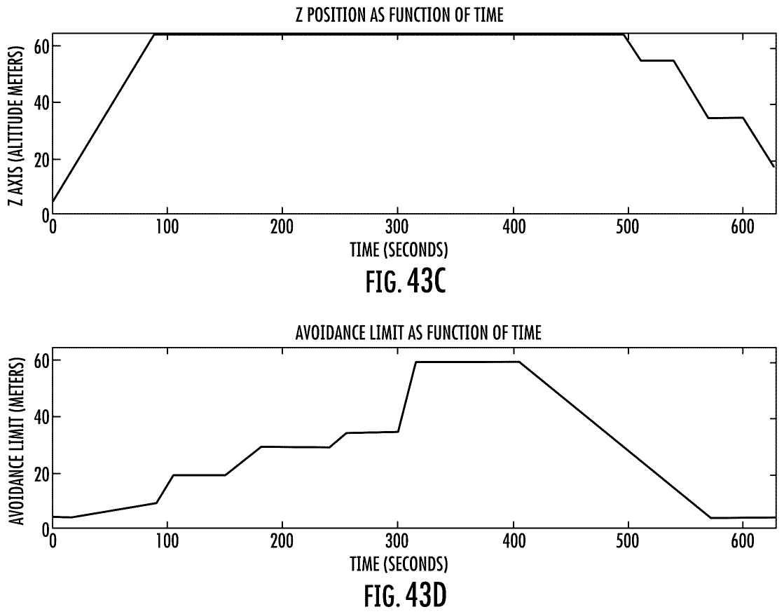

A trajectory may be generated by the autorouter system 544 for the drone 500 as shown in FIG. 3, starting at the right and moving to the left. This graph represents X, Y, and Z and each segment is assigned a velocity profile based on the drone 500, its mission, and environmental factors, taking the drone velocity and acceleration limits into account as shown in the graphs of FIGS. 41A, 41B, 42A and 42B. The independent spatial trajectories are then shown as a function of time in the graphs of FIGS. 43A-43D.

The first second of the Z trajectory is shown in the graph of FIG. 6, and the third second is shown in the graph of FIG. 8 as generally described above. Connecting each second of the control velocity to match the trajectory, the first five seconds look like the graphs of FIGS. 41A and 41B. With 5 m/s random wind gusts and drag added, it is shown as in the graph of FIG. 10 as had generally been described above.

For each segment, the CPR system 502 fits the acceleration and velocity limits applicable to the drone 500. The dots on the graph of FIGS. 41A and 42A indicate corners where the drone 500 must slow to its minimum velocity, then accelerate until the drone has reached the most velocity it can before it begins to slow again coming to the next corner. The trajectory determines its own time, which is derived by the motion of the drone 500. The velocity is not just “guessed at” by the CPR system 502 operating at the flight control unit 510, but it is perfected by the conversion to the 4D system. The drone 500 has now created the exact time it will reach its goal. When the CPR system 502 adds up the curves above for the full trajectory, it gives the exact time the drone will arrive at any point in the trajectory.

In the graphs shown in FIGS. 43A-43D, the 4D trajectory is now split into independent functions with respect to Time. The usual three spatial dimensions are denoted as X, Y, and Z, and control system dimensions and variables are expressed as a function of time. In these graphs, the Avoidance Limit (AL) as the sphere around the drone 500 becomes part of the trajectory.

During flight, the trajectory is viewed as a whole and not segments. This allows the CPR system 502 to use time in a fluid and flexible manner to determine what the velocity needs to be. Referring again to FIG. 8, the graph shows the parabolic velocity control calculated by the Continuous Path Regulator (CPR) system 502 for the third second. In the graph of FIG. 10, the continuous velocity profile for the first five seconds of the drone flight is shown.

In the third second, the altitude has peaked as marker 1005 in FIG. 10 and met its target of 0.92 m/s. The trajectory settles at 0.885 m/s. The difficulty is that external forces have caused errors where the distance travelled would be incorrect if the velocity leveled out. To maintain velocity and position, the velocity should decrease slightly as shown in FIG. 10 at marker 1010 before ending at the trajectory target.

The graph of the source trajectory vs the actual path is shown in FIG. 17 as had been generally described above. This includes drag and random wind shifts of up to +/−5 m/s as shown in the graph of FIG. 13, while the graph of FIG. 18 as generally described above shows a close-up of the source trajectory versus actual path so that it is easier to see how the CPR system 502 reacts to sudden changes in wind velocity. At a major change, as in FIG. 18 marker 1810, the CPR system 502 first detects the error. In this case, the sample rate of the position fix is one second, and the error is corrected two more sample times.

A simulation was also accomplished for a real world example of applying the CPR system 502 to control a linear induction motor or similar actuator. In this example, a Linear Induction Motor (LIM) system having eight linear induction motors is used to launch a rollercoaster, indicating the CPR system may be used for more than just drones. The launch energy required will be highly dependent on the rollercoaster car's entry velocity as determined by its weight into the rollercoaster launch rail, which varies from 26 f/s to 42 f/s. To keep throughput at its maximum capacity, an objective of the CPR system 502 applied with this rollercoaster example is to keep the time of launch, i.e., the time it takes to reach the top of the known slope, and the exit velocity at the top as consistent as possible as the exit velocity determines the time it will spend in the next section of the track. In this case, the length of the track (X1−X0) is known, the Time (T1) is known, and the velocity (V1) is known. The Continuous Path Regulator (CPR) system 502 will generate the mathematically correct parabolic velocity curve for the velocity of the rollercoaster car entering the track.

This is similar to the drone control case in that for each position fix, the current position, velocity, and time are known, and the trajectory gives the distance to be achieved in the next period of time and the velocity that the rollercoaster needs to achieve to stay on trajectory. In the drone case, this yields the velocity profile required for the next time period of drone flight, but in this real case of the rollercoaster, executing that profile is not a direct case of feeding the profile to the flight control unit 510 of the drone 500.

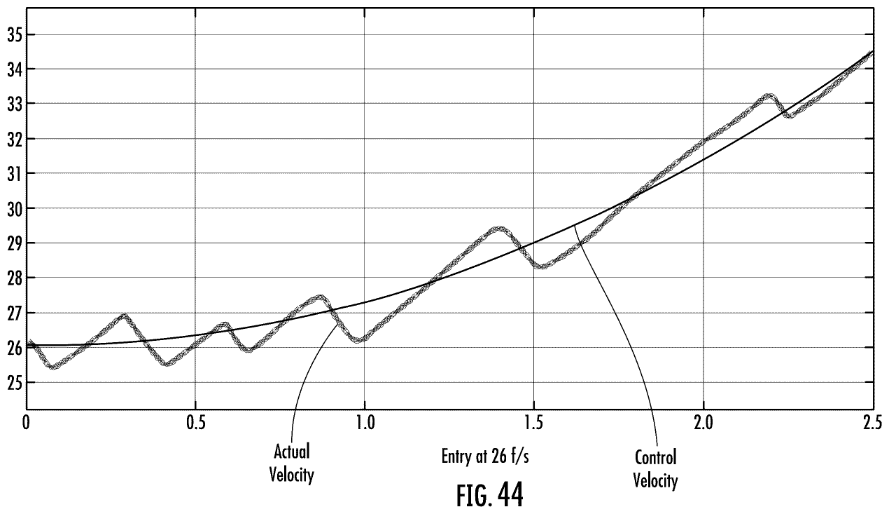

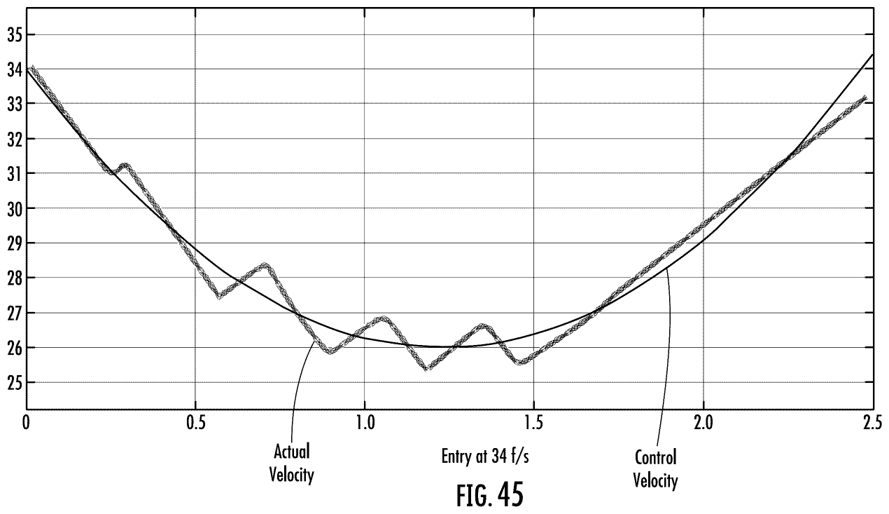

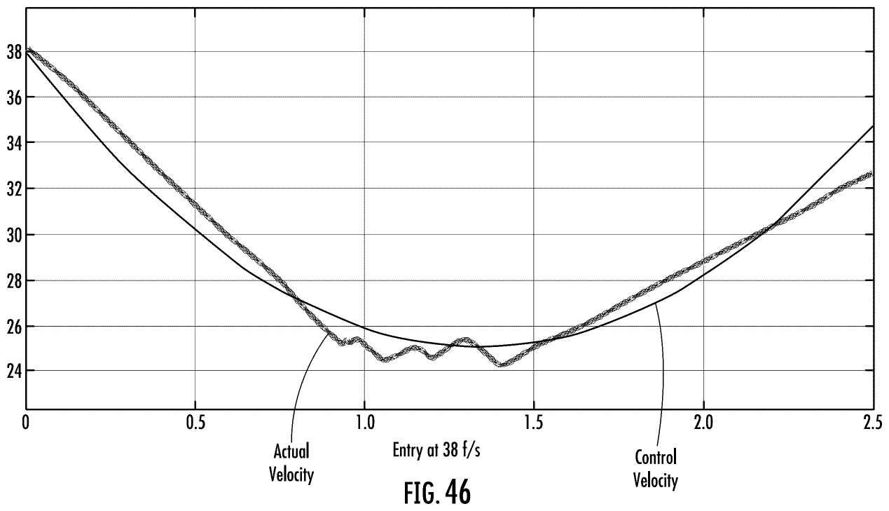

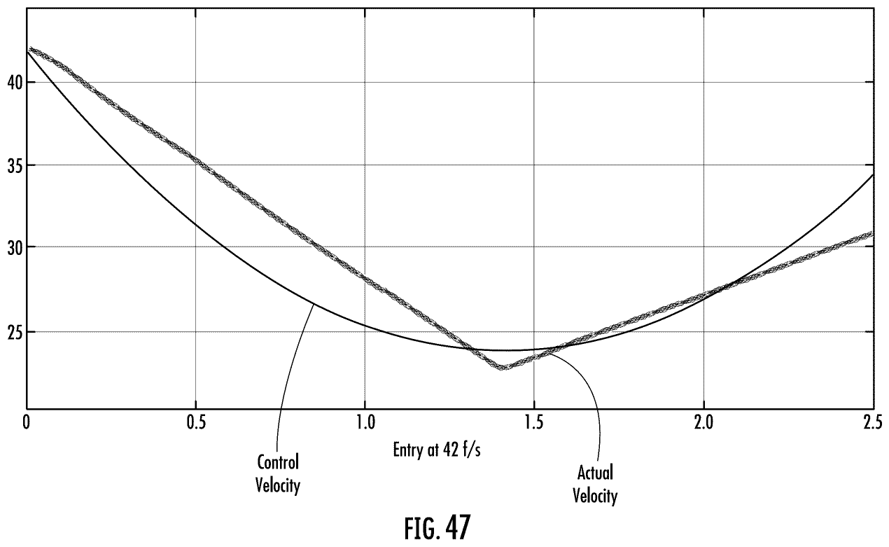

The challenge in this example is that there are eight (8) Linear Induction Motors (LIMs), which can only be turned on or off. The graphs of FIGS. 44-47 show the Continuous Path Regulator system calculating the correct parabolic velocity curve shown by the solid curved line with the different feet per second entry speed. From there, it is possible to calculate which LIMs will be ON or stay OFF, and the ON time for each LIM to keep as close to that curve as possible. A perfect run would have the jagged line and curved line meet exactly at the end as in the example of FIG. 44.

This actual use case for the rollercoaster applies the Continuous Path Regulator system 502 in a similar manner to the example drone. For example, given the V0 velocity coming into the launch, and the known X1, T1, and V1, the CPR system 502 computes the best velocity to solve all three. The only difference is the algorithm of the CPR system 502 in the drone 500 passes this information to the flight controller 520 operating with the flight control unit 510, and in the rollercoaster example, on the other hand, the information is sent to the LIM controller and the best trajectory is the result.

Returning to the drone 500 example again, the drones maintained precise adherence to planned velocity parabolas even under both significant random and constant disturbance. Fleet level orchestration using the fleet and hub autorouters as the autorouter system 544 produces conflict-free paths for hundreds of drones 500 in dense airspace, such as the illustrated cityscapes, without exponential slowdown. This occurs, however, only if the drones 500 can remain on time, on velocity, and on position as part of fleet level orchestration. At the fleet level with many drones 500, without precise timing and exact adherence, pads jam up, departures queue, and cost per drone stays high. The CPR system 502 and fleet and hub autorouters operating together as the autorouter system 544 solve this bottleneck by 1) preventing overshoot and oscillation so drones 500 launch and land cleanly without extra buffer time; 2) smoothing trajectory changes, so avoidance maneuvers do not cause cascading delays; 3) scheduling each flight as a 4D trajectory in space and time so arrivals and departures are deconflicted before they happen; and 4) keeping pad utilization steady even at high density, nearly doubling flights per pad per hour compared to conventional controllers.

Even with perfect drone control, fleets of drones 500 collapse without precise scheduling, such as now provided by the fleet and hub autorouter system 544. Existing prior art approaches like reactive detect-and-avoid or decentralized “best effort” navigation fail exponentially as density increases, and thus, predictability vanishes and cost per drone becomes unsustainable.

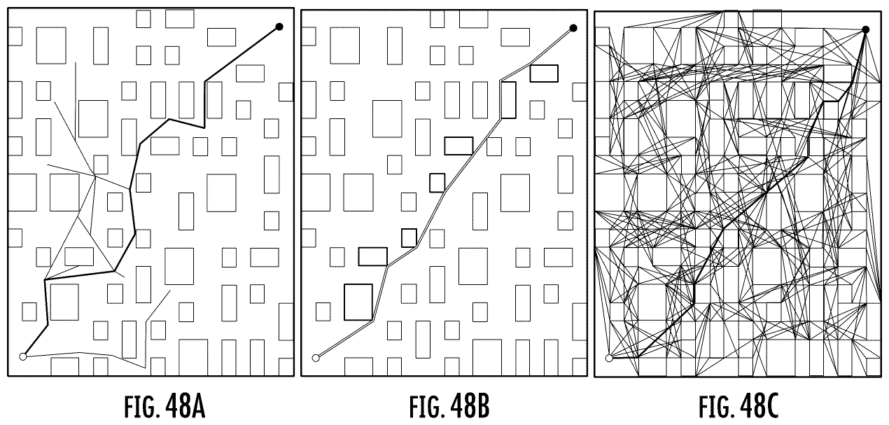

The autorouter system 544 using the fleet autorouter 554 and hub autorouter 556 operates as a drone fleet orchestrator and addresses this by computing full trajectories from takeoff to landing in four dimensions (X, Y, Z, T), and ensuring every drone has a precise, non-conflicting path. The autorouter system 544 as shown in the examples of FIGS. 48A-48C is faster than probe-based routers, such as RRT* and Visibility Graph, and still capable of applying cost functions. FIG. 48A-48C show the comparison of RRT, Hull Router, and Visibility Graph autorouting and their defects. Thus, the autorouter system 544 of the invention finds more than the shortest path, but the best path, balancing drone fleet needs, time, energy, and safety.

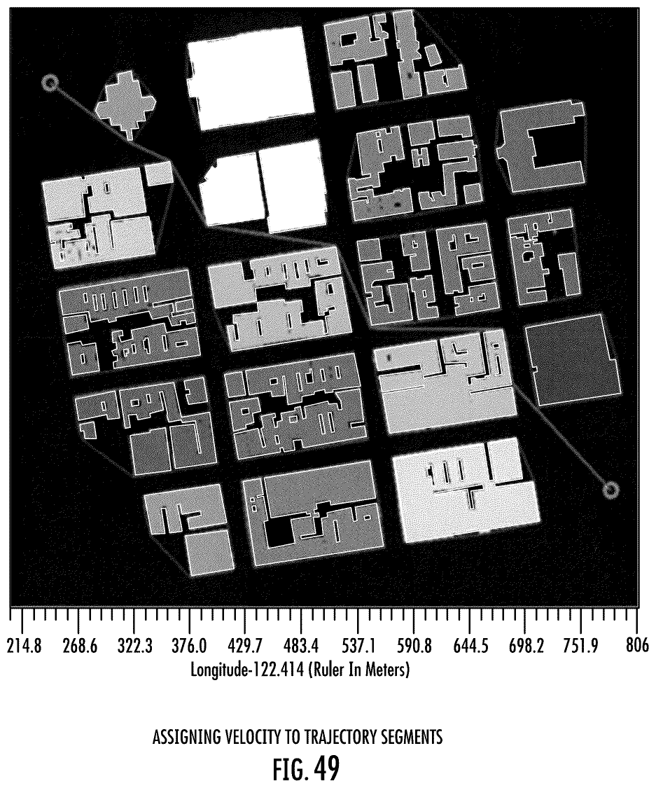

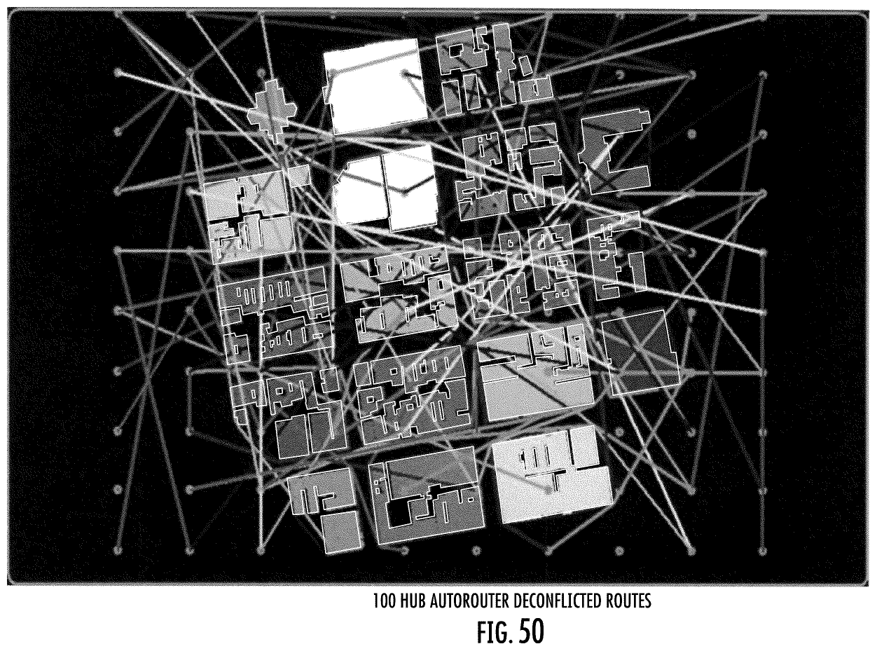

The second aspect for the autorouter system 544 is the embedding of mathematical velocity curves into every line and arc of the trajectory, which incorporates the time dimension directly into flight planning as shown in the cityscape example of FIG. 49, illustrating the defined path at the trajectory through the buildings. The third aspect is the projection of dependent XYZ motions into the time domain, converting them into independent functions of T. This makes it possible to compute exact positions and velocities at every instant, with true 4D precision.

This orchestration of the fleet of drones 500 using the autorouter system 544 and CPR system 502 at each drone 500 converts chaotic avoidance maneuvers into deterministic scheduling. In the example of FIG. 50, the autorouter system 544 connects 100 simultaneous points in about four square blocks of the cityscape as also shown in FIG. 49.

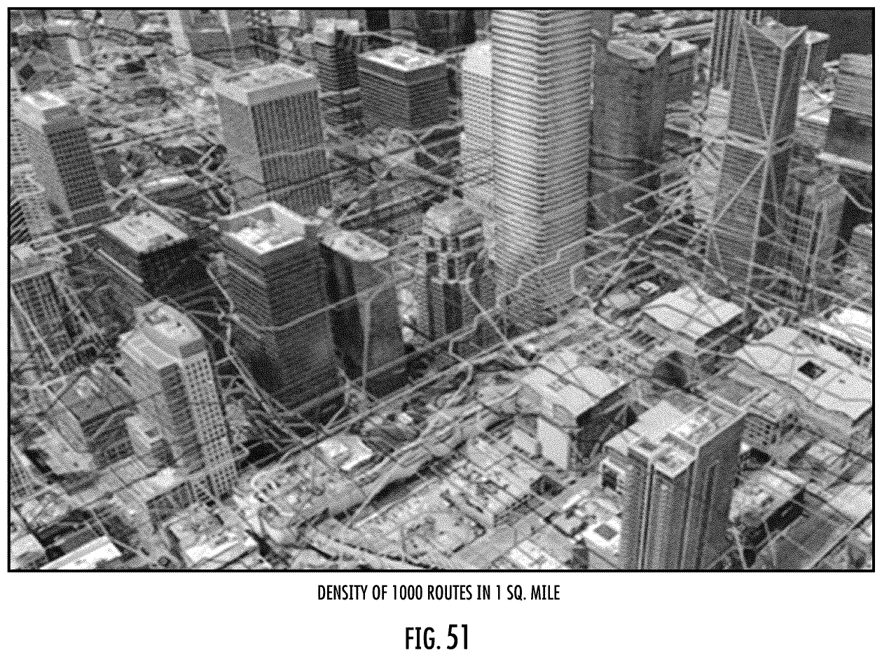

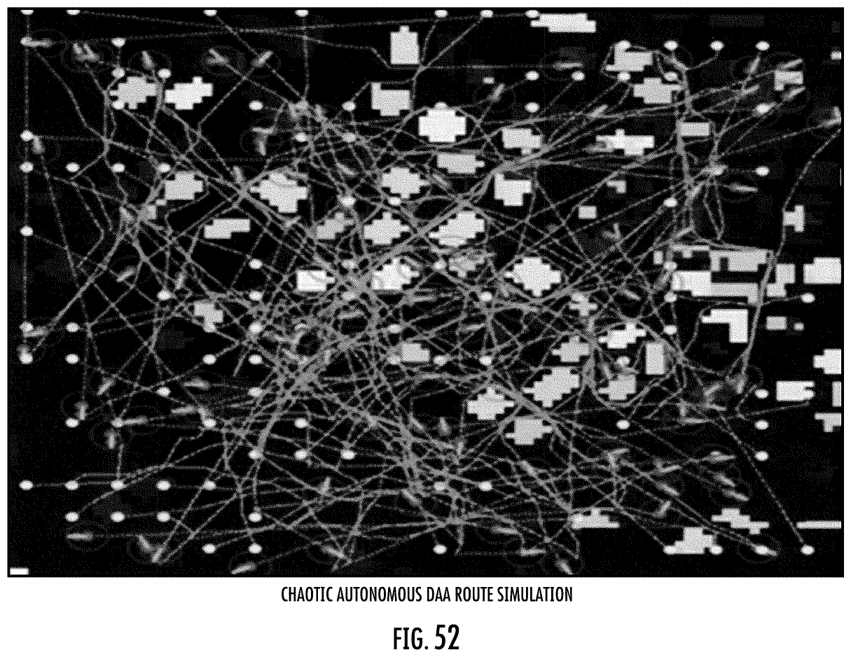

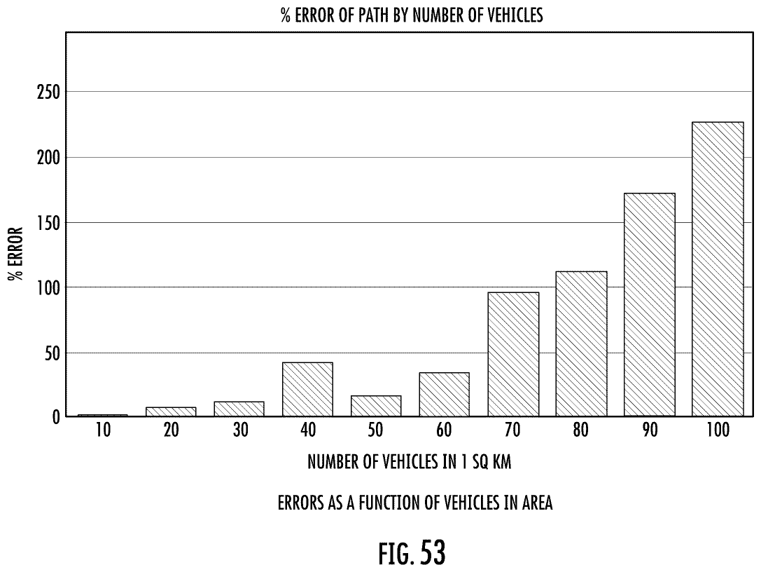

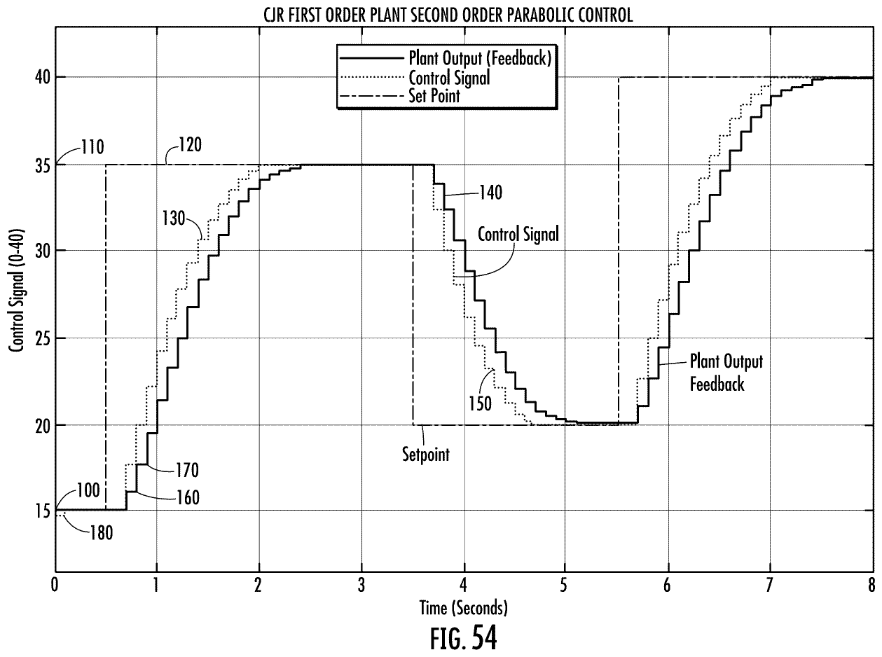

In the three-dimensional, perspective view of a cityscape example of FIG. 51, an example autorouter system 544 with cost functions is shown where over 1,000 drones were routed through one square mile of San Francisco's financial district, each with guaranteed space-time separation. By contrast to a prior art technique shown in FIG. 52, simulations of autonomous drones navigating in “Detect And Avoid” mode is shown in the plan view of the cityscape of FIG. 52, and shows the chaotic nature of the trajectories with high numbers of drones. The bar chart shown in FIG. 53 illustrates that without orchestration the total path of reactive systems can more than double the expected flight times.

Scaling urban drone operations requires tight pad spacing and narrow transit corridors. The autorouter system 544 and the CPR system 502 operate together as a fleet orchestrator and use a 4D routing graph that handles multiple drone types as VTOL and fixed-wing drones and even ground vehicle drone robots. Drones 500 can safely traverse overlapping corridors and shared transition nodes by embedding time separation directly into their trajectories. Launch and recovery throughput is maximized because drones 500 are guaranteed to be on position, on velocity, and on time at every node, such as a Waypoint. A separate routing algorithm may be integrated into the trajectory construction specifically to handle tight and complex takeoff and landing pad configurations in 4D. Drone flights may take off and land with high precision without buffering.

The takeoff and landing or “hub” autorouter 556 aspect of the autorouter system 544 is designed to handle complex and crowded takeoff and landing pads. Given the desired throughput rate, the pad definitions, and the amount of airspace allocated to the transition, the autorouter system 544 automatically generates a graph of sufficient size, altitude, and drone buffering capacity to allow seamless control of the air space.

The autorouter system 544 provides trajectory planning that may operate in dense urban corridors, high-volume pad operations, and long-range transfers to provide 4D routing. Every path is delivered as a time-precise trajectory, ready for the CPR system 502 operating at the flight control unit 510 in each drone 500 to execute the flight plan with mathematical fidelity. The CPR system 502 provides no bottlenecks at pads since launch and landing windows are assigned as precise departure slots by the autorouter system 544 operating at the drone traffic control flight center 540, eliminating conflicts and queues. The CPR system 502 provides predictable concurrency. Instead of reactive detect-and-avoid as in prior art conventional systems, every drone 500 has a deconflicted schedule already preplanned in the drone now and loaded into the flight control unit 510. That predictability is what drives pad utilization up and cost per drone 500 down.

There is also system-wide optimization where the autorouter system 544 can choose not only the shortest path, but also the best path by minimizing energy, balancing workloads, and prioritizing high-value deliveries. The CPR system 502 and autorouter system 544 operate for scalability where conflicts are avoided by design without exponential compute costs or delays. The CPR system 502 and autorouter system 544 scale with fleet size. With the autorouter system 544, every drone 500 is part of a scheduled choreography, transforming the drone fleet from a collection of drones into a scalable drone delivery network.

Conventional prior art PID controllers struggle in this context because those PID controllers assume the control system can be linearized. These known controllers require meticulous gain tuning, which works only within narrow operating ranges. Model Predictive Control (MPC) and Linear Quadratic Regulators (LQR) extend their framework with optimization, but they are computationally intensive and may demand approximations.

The Curve Junction Regulator (CJR) system 550 of the current invention operates with the CPR system 502 at the flight control unit 510 and overcomes these limitations by eliminating the need for both linearization and tuning. The CJR system 550 adapts naturally to nonlinear drone actuator dynamics, such as motor controls for propellers, actuators for flap and other drone sharing controls and drone guidance systems, and uses higher order templates as unit polynomials for parabolas and sigmoids to generate smooth, overshoot free transitions between setpoints. Instead of measuring error as a position or velocity gap, the CJR system 550 measures time alignment as the difference between where the drone 500 is located and where any actuators 530 are positioned and where they should be on the template at that instant. This new time-based error metric allows the CJR system 550 to synchronize the drone 500 to the curve, regardless of how quickly or slowly the drone responds. This fundamental difference allows for any changes that alter the response. Conditions can be matched such as payload, drone weight under rainy conditions, propeller wear and similar factors, for example.

In practice, the CJR system 550 also provides a rapid, reliable method to transition from one trajectory to another. Whenever a drone 500 must deviate from its planned path whether to execute an avoidance maneuver, handle an emergency, adjust to a changed trajectory or revector during takeoff and landing, the CJR system 550 generates the smooth interpolation from the current trajectory to the new one. The CJR system 550 has versatility with polynomial templates that handle light and heavy loads without oscillation. Sigmoid templates maintain stability even under injected noise, and bang-bang actuators if used in a drone 500 or similar application can be stabilized with parabolic control curves. In drone 500 operations, the CJR system 550 complements both the Continuous Path Regulator system 502 and the autorouter system 544 as the fleet orchestrator. It ensures that when conditions change unexpectedly, transitions remain precise, smooth and deterministic. Given a change to the setpoint of the flight controller 520 operating with the flight control unit 510, for example, the flight controller 520 adapting to a necessary change to drone actuators 530, including motors and other drone guidance components, it is possible to output a series of control values to these guidance components as part of the drone or flight navigation system 514, which guides the drone 500 to meet the setpoint value without overshoot, undershoot, or oscillation and without tuning of parameters, allowing efficient optimum responses.

The graph in FIG. 54 shows the response curve for the CJR system 550 to control a first order model of a drone actuator 530 of the drone navigation system 514, such as a flap or motor control with a second order template. The setpoint is shown by marker 120. The control signal generated by the CJR system 550 is shown as marker 130, and the actual output of the actuator control is the solid line 140.

A known prior art PID control may produce a similar parabolic response iteratively, but the CJR system 550, on the other hand, produces the parabolic response from first principles. A substantial difference in the CJR system 550 over the prior art conventional PID is that the conventional PID creates a new output signal on a timed basis computed from the difference between where the drone actuator is and where it should be as the setpoint. It pushes the drone actuator control to reduce the error. This starts out as a linear slope (P Term), which is known to be incorrect, but was derived from “tuning” the PID. The prior art drone controller using the PID then adds the I term to push or retard the control signal as appropriate. This causes undershoot, overshoot, and oscillation. The D term is then added to dampen the oscillation.

The CJR system, on the other hand, starts with a measured impulse in the control signal, which is also assumed to be in error. The drone actuator control as part of the guidance system, such as a motor control response, is not yet known because there is no tuning. The time and magnitude of the drone control response via instructions from the flight control unit 510 may be longer or shorter depending on load and other drone dynamics. The drone control response for the actuator, for example, whatever it is at the moment, is then used to calibrate the timing and magnitude of the next control output. The error term is the difference in time and magnitude of the drone control response, so the next response is not time driven, it is slaved to the drone control. As the drone control nears the setpoint, the template curve as a parabolic or sigmoid curve or even higher order curve acts as a gain control to the output to guide the drone control via the flight control unit instructions to the actuator or other component of the drone guidance system directly to the setpoint.

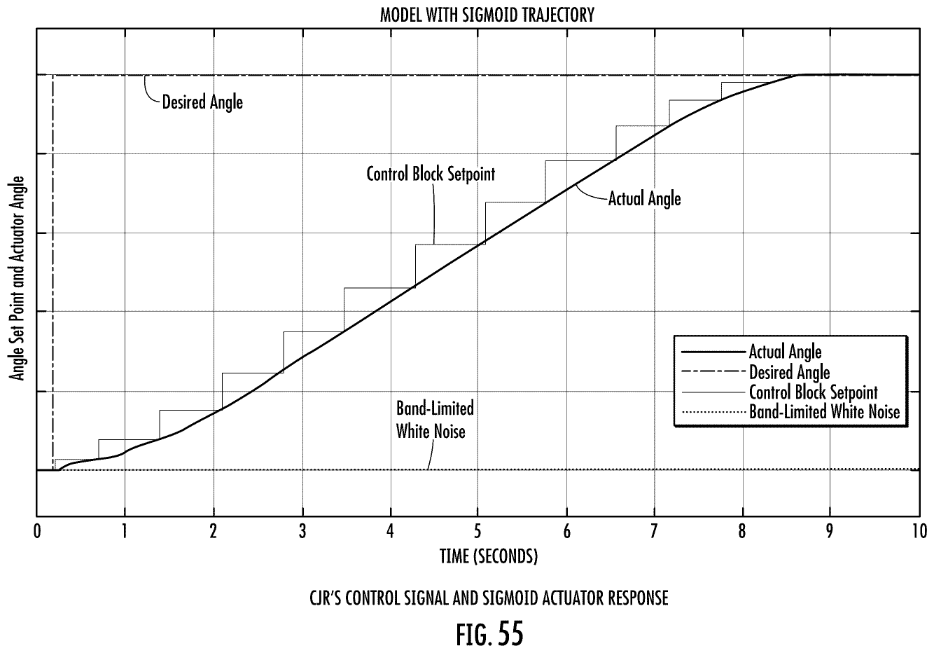

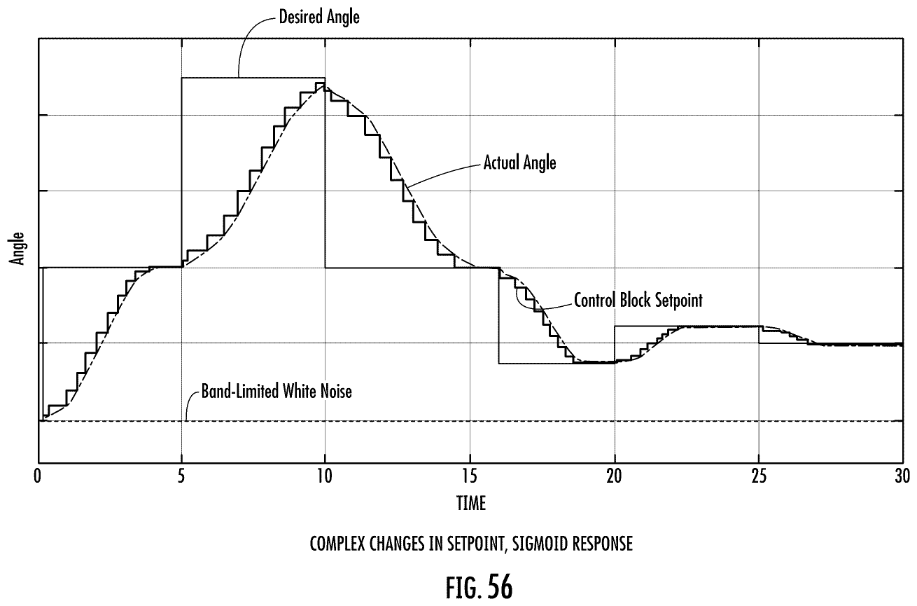

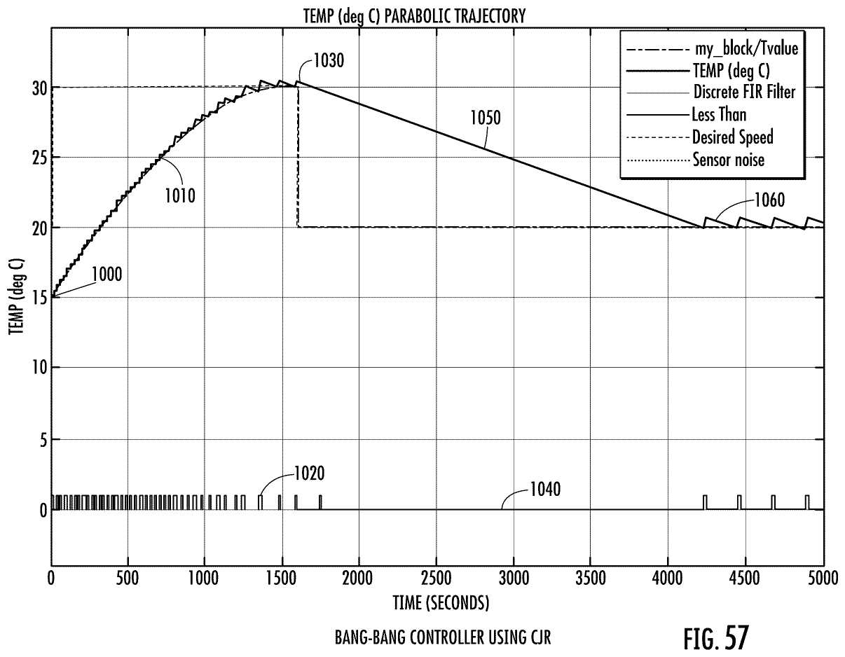

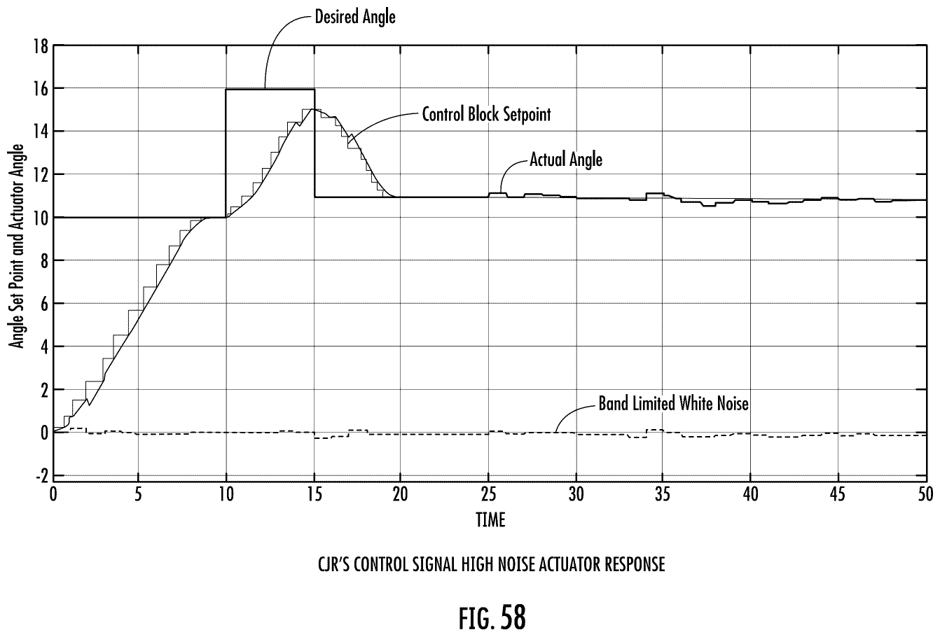

The graph in FIG. 55 shows the CJR system 550 response to a sigmoid as a higher order for a model of drone control. The prior art existing PID controller cannot produce this output. The graph in FIG. 56 shows a complex sigmoid response where the setpoint changes before the drone has had time to fully respond. The graph in FIG. 57 shows the use of the CJR system 550 in a bang-bang controller configuration that may be employed with the drone guidance system, while FIG. 58 shows a graph with the system response and high noise where the CJR system has a control signal and high noise actuator response.

The Continuous Path Regulator system 502 and autorouter system 544 operate together as a two-layer drone control architecture that defeats the bottleneck in urban drone delivery, i.e., throughput. At the drone level, the Continuous Path Regulator (CPR) system 502 computes exact, closed-form velocity trajectories such as parabolic velocity profiles projected into time so that position, velocity and schedule are simultaneously satisfied. At the drone fleet level, the autorouter system 544 computes full 4-D (X, Y, Z, T) trajectories for every drone, providing routing not just for minimum distance but for fleet-optimal cost functions and time separation, using the fleet and hub autorouters as part of the autorouter system 544. Where a planned trajectory must change in flight, the Curve Junction Regulator (CJR) system 550 generates smooth, higher-order transitions as parabolas and sigmoids so deviations never induce oscillation or require hand tuning.

Details of an example of the CJR system 550 that can be used with complete drone control is disclosed in commonly assigned U.S. patent application Ser. No. 18/325,389 filed May 30, 2023, the disclosure which is hereby incorporated by reference in its entirety.

The CJR system 550 helps automate control of an actuator 530 driving a motor or flap or other drone guidance component to make control from the CPR system 502 more smooth. The CJR system 550 may use a programmable controller that operates as part of the flight control unit 510 and generate a template curve that may include a defined number of actuator steps to achieve an overall change from an initial actuator step value to a final actuator step value. For example, the actuator 530 may be a drone motor or actuator controlling a flap or other drone guidance component on the drone. Each of the defined number of drone actuator steps has a respective change between a respective actuator step initial value and a respective actuator step final value. The template curve may be generated based on at least a third order polynomial velocity function defining a sigmoid, or in an example parabola, that extends between the initial actuator step value and the overall final actuator step value.

The controller as part of the flight control unit 510 determines a respective actuator control signal value for each of the defined number of drone actuator steps. In this example, the respective actuator control signal value for each of the defined number of actuator steps may be determined based on a relative magnitude of the respective actuator step value change with respect to the actuator step overall change. The controller as part of the flight control unit 510 may be configured to detect a difference between the setpoint of the drone actuator and maximum known value of the setpoint as an initial output actuator control signal value.

The controller as part of the flight control unit 510 may calculate the number of drone actuator steps relative to the template curve for each sample of the actuator output, compare the slope of the actuator control signal value setpoint as the desired angle, heading, position or bearing or other guidance system aspect of the drone, for example, and current angle, heading, position or bearing of the drone to set a next actuator control signal value.

At each sample, if the actuator step value has met or exceeded a polynomial velocity function value, then all steps of the polynomial velocity function value may be repeated until a complete drone actuator step final value is achieved. Time may be applied as a variable and an error term defined as the time difference between the template curve and an actual actuator step value. The controller as the flight control unit 510 may be configured to modulate the time represented by steps in the template curve to reach a setpoint at a vertex of the template curve and hold at each drone actuator step value until the error is removed by the actuator step value reaching a desired template curve step point and continuing with a new step point and new error value.

The controller as the flight control unit 510 may initially output a reference actuator control signal value and measure a response of the actuator step value that is induced by the reference actuator control signal value. The controller as the flight control unit 510 may generate a template curve using the response of the actuator step value and may use the reference actuator control signal value as a maximum value when determining the actuator control signal values. The controller as the flight control unit 510 may be operable to use a lower actuator control signal value than the maximum actuator control signal value to achieve a slower response of the actuator step value.

The controller as the flight control unit 510 may also use the response of the drone actuator step value to correlate the respective actuator control signal value for each of the defined number of actuator step values to the relative magnitude of the respective actuator step value change with respect to an overall change. The controller as the flight control unit 510 may optimize the defined number of drone actuator step values. The final tangent to the template curve at a final actuator step value may be zero. An initial tangent to the tangent curve on the initial actuator step value may be zero. The actuator control signal, such as a motor control signal value, may be an on/off or go/no go control signal value and the respective actuator control signal values may include at least on/off frequency and on/off duration values.

Some prior art conventional drone guidance systems focus on incremental improvements in sensing, which mandates intensive computational resources for MPC/LQR, or focus on better reactive avoidance. These prior art conventional drone guidance systems often fail at scale, i.e., they are reactive stacking of fixes that still rely on iterative convergence and tuning. By contrast, the CPR system 502 and corresponding CJR system 550 and autorouter system 544 reframe the problem and compute deterministic space-time slots for every drone 500 and gives each drone a closed-form velocity plan that guarantees it arrives on those time slots. That removes the core cause of scaling failure as uncertainty in time rather than masking it.

The CPR system 502 and autorouter system 544 mitigate vulnerabilities and address state-estimation failures and position errors where GPS/RTK outages, multipath, and degraded GNSS in crowded urban areas may cause position error or jumpiness. The CPR system 502 assumes the navigation fix at the correction time is reasonably accurate. Large position biases may force larger corrections and may push actuators 530 and related flight guidance components into saturation or lead to temporary AL (Avoidance Limit) violations. The CPR system 502 and autorouter system 544 may also adapt to latency and timing jitter. Navigation updates, telemetry, and command transport, e.g., radio/MAVLink latency, packet loss, may create asynchronous inputs. The Continuous Path Regulator system 502 may work with asynchronous input timing.

The CPR system 502 and autorouter system 550 may address drone guidance systems, such as actuator saturation and nonlinearity. There are motor limits, ESC rate limits, battery voltage sag under load, prop-wash interactions, and aerodynamic nonlinearities especially near ground or buildings that can prevent the drone 500 from achieving the commanded parabola within the sample interval, which are addressed by the CPR system 502 and autorouter system 544. There may be some model mismatch and unmodeled dynamics, but these can be bridged. Sensor 524 noise and bias is addressed. Any IMU drift, magnetometer errors, or pressure sensor offsets, such as altimetry, may be transient biases that feed into both a state estimator and the control solution. While the CPR system 502 may recompute each cycle, some persistent biased estimates may produce systematic error, which may be corrected with a second filter.

The autorouter system 544 at the drone traffic control flight center 540 assigns a complete 4D trajectory as Waypoints with timing and avoidance limits and nominal velocities for each drone from pad to pad. There may be navigation interpolation as part of the CPR system 502 where the onboard flight control unit 510 includes a navigation module that receives the segment definition and produces, at each navigation sample interval, the next segment start/end states (Z0,V0,T0→Z1,V1,T1).

The flight control unit 510 that implements the Continuous Path Regulator system 502 computes the parabolic velocity profile per axis for the next interval and evaluates a sequence of velocity setpoints over time. The CJR system 550 complements and provides transition/disturbance handling. If the trajectory must change mid-flight with avoidance and new clearance, the CJR system 550 may compute a smooth higher order template as parabola or sigmoid, bridging the current state to the new trajectory. It may output a sequence of intermediate target values (Tvalue) that respect capabilities.

The flight control unit 510 may include a command interface and controller setpoints, where a navigation and control stack for the drone navigation system 514 does not transmit raw motor PWM. Instead, it may transmit high-level setpoints, e.g., desired velocity vector, yaw rate, or position/velocity/time setpoints. The flight control unit's inner loops as attitude and rate controllers may translate those into actuator 530 commands for a drone motor or other actuator and ESC PWM/torque using its own high-rate control loops. There may be inner loop execution with attitude/rate loops operating at the highest frequency for hundreds to a thousand Hz and ensure the drone follows the provided outer loop setpoints. The Continuous Path Regulator system 502 and CJR system 550 may respect the bandwidth and authority of these loops.

The flight control unit 510 may operate an inner-loop as attitude/rate at about 200-1,000 Hz and may be closed by its firmware. The outer loop/position/velocity control for the flight control unit 510 may operate at about 20-200 Hz and may accept position/velocity updates at 50 Hz comfortably. Some velocity setpoints may be at 10-50 Hz. There may be an onboard navigation system and Continuous Path Regulator system 502 update where the main correction for the CPR system may include computing a new parabola at the flight control unit 510 and may run at 5-20 Hz as a sample time. The computation load may be low, making it capable of 1000 Hz or more. There are telemetry and radio limits such that common radios saturate if the system pushes greater than 50-100 small messages per second continuously when receiving data. Adding many drones multiplies aggregate load and it may be desirable in some cases to maintain traffic minimal and send a compact stateful setpoint as a vector and timestamp rather than a stream of micro-commands if possible.

There are practical initial parameters where the fleet orchestration for the autorouter system 544 and navigation update rate may be around 5-20 Hz as the correction cadence. To provide finer granularity for smoothing, the flight control unit 510 may generate local subsamples, but send aggregated or time-stamped commands, which the flight controller 520 or other flight guidance module as operative with actuators 530 may interpolate at 50-100 Hz internally to avoid sending hundreds of independent small messages per second. The processor of the flight control unit 510 may monitor bus utilization and set conservative safety throttles, e.g., a fallback to 10 Hz, if the CPU or radio load crosses thresholds.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims.

1. An autonomous unmanned aerial vehicle (UAV), comprising:
a flight control unit (FCU);
vehicle sensors operative with the FCU to provide real time position, orientation and velocity of the UAV during flight;
a UAV flight controller connected to the FCU; and
flight actuators operative with the FCU and configured to receive a control signal from the UAV flight controller and control UAV flight along a preplanned flight trajectory;
said FCU having stored therein a preplanned flight trajectory comprising a trajectory start time and position and a trajectory end time and position within a geographical area of operation (AO) that the UAV operates that is conflict free from flight trajectories of other UAVs operating within the geographical AO, the flight trajectory including a plurality of preplanned trajectory waypoints defining flight segments, each flight segment comprising a parabolic function for each of X, Y and Z positions projected separately as a function of time, said FCU configured to,
initiate the UAV flight according to the stored, preplanned flight trajectory starting at its preplanned trajectory start time and position,
receive data during flight from the vehicle sensors and process real time position, orientation and velocity during flight and for the beginning of each flight segment,
compute a new position and velocity for each corresponding flight segment,
update the parabolic function for each of the X, Y and Z positions projected separately as time for each respective flight segment to correct for any errors in the flight of the respective UAV that deviates from its preplanned flight trajectory,
operate the flight controller to control the flight actuators and correct for any deviation in the flight within that flight segment and bring the UAV back on time, on position and on velocity by the end of that flight segment corresponding to the next successive waypoint as established by the preplanned flight trajectory, and
repeat for each respective flight segment to maintain flight of the UAV along the preplanned flight trajectory.

2. The UAV of claim 1 wherein the preplanned flight trajectory comprises an Avoidance Limit (AL) as an area around the respective UAV flying its preplanned flight trajectory at every point in time that allows for errors induced by wind and load variations and slight trajectory deviations.

3. The UAV of claim 2 wherein for each segment of the flight trajectory, the FCU is configured to update the parabolic function for each of the X, Y and Z positions such that the UAV reaches the next waypoint at the prescribed time and position and stays within the Avoidance Limit.

4. The UAV of claim 1 wherein the vehicle sensors comprise a GPS device and Inertial Measurement Unit having an accelerometer and gyroscope.

5. The UAV of claim 4 wherein the vehicle sensors comprise a LIDAR (Light Detection and Ranging) device that generates 3D map data to the FCU to process for obstacle avoidance within each segment of the preplanned trajectory.

6. The UAV of claim 1 wherein the FCU is configured to generate a new parabolic function as a parabolic curve for each of the X, Y and Z functions that converges to the correct position, velocity and time of the next successive waypoint corresponding to the beginning of the next successive segment in the preplanned flight trajectory.

7. The UAV of claim 1 wherein the flight actuators comprise at least one of drone motors and guidance components.

8. The UAV of claim 7 wherein the FCU is configured to generate a template curve at each flight segment during flight deviations based on a third order polynomial velocity function defining a sigmoid for an actuator control signal having a defined number of actuator steps to achieve an overall change from an initial actuator step value to a final actuator step value defined by the sigmoid, and said flight controller in response is configured to control the vehicle actuators in a non-linear manner to smooth transitions when a flight deviation is required during drone avoidance maneuvers, mid-flight trajectory changes and takeoff/landing corrections.

9. A method of operating an autonomous unmanned aerial vehicle (UAV) that comprises a flight control unit (FCU) vehicle sensors operative with the FCU to provide real time position, orientation and velocity of the UAV during flight, a UAV flight controller connected to the FCU, and flight actuators operative with the FCU and configured to receive a control signal from the UAV flight controller and control UAV flight along a preplanned flight trajectory, the method comprising:
storing within the FCU a preplanned flight trajectory comprising a trajectory start time and position and a trajectory end time and position within a geographical area of operation (AO) that the UAV operates that is conflict free from flight trajectories of other UAVs operating within the geographical AO, the flight trajectory including a plurality of preplanned trajectory waypoints defining flight segments, each flight segment comprising a parabolic function for each of X, Y and Z positions projected separately as a function of time, said FCU configured to,
initiating the UAV flight according to the stored, preplanned flight trajectory starting at its preplanned trajectory start time and position,
receiving data during flight from the vehicle sensors and process real time position, orientation and velocity during flight, and for the beginning of each flight segment,
computing a new position and velocity for each corresponding flight segment,
updating the parabolic function for each of the X, Y and Z positions projected separately as time for each respective flight segment to correct for any errors in the flight of the respective UAV that deviates from its preplanned flight trajectory,
operating the flight controller to control the flight actuators and correct for any deviation in the flight within that flight segment and bring the UAV back on time, on position and on velocity by the end of that flight segment corresponding to the next successive waypoint as established by the preplanned flight trajectory, and
repeating for each respective flight segment to maintain flight of the UAV along the preplanned flight trajectory.

10. The method of claim 9 wherein the preplanned flight trajectory comprises an Avoidance Limit (AL) as an area around the respective UAV flying its preplanned flight trajectory at every point in time that allows for errors induced by wind and load variations and slight trajectory deviations.

11. The method of claim 10 wherein for each segment of the flight trajectory, the FCU is configured to update the parabolic function for each of the X, Y and Z positions such that the UAV reaches the next waypoint at the prescribed time and position and stays within the Avoidance Limit.

12. The method of claim 9 wherein the vehicle sensors comprise a GPS device and Inertial Measurement Unit having an accelerometer and gyroscope.

13. The method of claim 12 wherein the vehicle sensors comprise a LIDAR (Light Detection and Ranging) device that generates 3D map data to the FCU to process for obstacle avoidance within each segment of the preplanned trajectory.

14. The method of claim 9 wherein the FCU is configured to generate a new parabolic function as a parabolic curve for each of the X, Y and Z functions that converges to the correct position, velocity and time of the next successive waypoint corresponding to the beginning of the next successive segment in the preplanned flight trajectory.

15. The method of claim 9 wherein the flight actuators comprise at least one of drone motors and guidance components.

16. The method of claim 15 wherein the FCU is configured to generate a template curve at each flight segment during flight deviations based on a third order polynomial velocity function defining a sigmoid for an actuator control signal having a defined number of actuator steps to achieve an overall change from an initial actuator step value to a final actuator step value defined by the sigmoid, and said flight controller in response is configured to control the vehicle actuators in a non-linear manner to smooth transitions when a flight deviation is required during drone avoidance maneuvers, mid-flight trajectory changes and takeoff/landing corrections.

17. A system of operating an autonomous unmanned aerial system, comprising:
a plurality of autonomous unmanned aerial vehicles (UAVs), each UAV comprising a flight control unit (FCU) and vehicle sensors operative with the FCU to provide real time position, orientation and velocity of the UAV during flight, and a UAV flight controller and flight actuators operative with the FCU that control UAV flight along a preplanned flight trajectory;
an Air Traffic Controller (ATC) having an autorouter configured to generate a preplanned flight trajectory for each of the plurality of UAVs operating within a defined geographical area of operation (AO), each preplanned UAV flight trajectory having a trajectory start time and position and a trajectory end time and position within the geographical AO, each preplanned UAV trajectory being deconflicted from the other preplanned UAV flight trajectories in position, velocity and time such that the preplanned flight trajectory for each UAV is conflict free from the other flight trajectories of other UAVs operating within the geographical AO;
each UAV flight trajectory comprising a plurality of preplanned trajectory waypoints defining flight segments, each flight segment comprising a parabolic function for each of X, Y and Z positions projected separately as a function of time;
wherein each UAV FCU is configured to
receive and store its preplanned flight trajectory before the UAV initiates its flight,
initiate the flight of its respective UAV according to its stored, preplanned flight trajectory starting at its preplanned trajectory start time and position,
receive data during flight from respective vehicle sensors and process real time position, orientation and velocity during flight and for the beginning of each flight segment,
compute a new position and velocity for each corresponding flight segment,
update the parabolic function for each of the X, Y and Z positions projected separately as time for each respective flight segment to correct for any errors in the flight of the respective UAV that deviates from the preplanned flight trajectory,
operate the flight controller to control the flight actuators and correct for any deviation in the flight of the respective UAV within that flight segment and bring the respective UAV back on time, on position and on velocity by the end of that flight segment corresponding to the next successive waypoint as established by the preplanned flight trajectory, and
repeat for each respective flight segment to maintain flight of the UAV along the preplanned flight trajectory and in a deconflicted manner with other UAV's operating within the geographical AO.

18. The system of claim 17 wherein each preplanned flight trajectory comprises an Avoidance Limit (AL) as an area around the respective UAV flying its preplanned flight trajectory at every point in time that allows for errors induced by wind and load variations and slight trajectory deviations.

19. The system of claim 18 wherein for each segment of the flight trajectory, the FCU is configured to update the parabolic function for each of the X, Y and Z positions such that the UAV reaches the next waypoint at the prescribed time and position and stays within the Avoidance Limit.

20. The system of claim 17 wherein the vehicle sensors in each UAV comprise a GPS device and Inertial Measurement Unit having an accelerometer and gyroscope.

21. The system of claim 20 wherein the vehicle sensors in each UAV comprise a LIDAR (Light Detection and Ranging) device that generates 3D map data to the FCU to process for obstacle avoidance within each segment of the preplanned trajectory.

22. The system of claim 17 wherein each FCU is configured to generate a new parabolic function as a parabolic curve for each of the X, Y and Z functions that converges to the correct position, velocity and time of the next successive waypoint corresponding to the beginning of the next successive segment in the preplanned flight trajectory for the respective UAV.

23. The system of claim 17 wherein the flight actuators for each UAV comprise at least one of drone motors and guidance components.

24. The system of claim 23 wherein the FCU is configured to generate a template curve at each flight segment during flight deviations based on a third order polynomial velocity function defining a sigmoid for an actuator control signal having a defined number of actuator steps to achieve an overall change from an initial actuator step value to a final actuator step value defined by the sigmoid, and said flight controller in response is configured to control the vehicle actuators in a non-linear manner to smooth transitions when a flight deviation is required during drone avoidance maneuvers, mid-flight trajectory changes and takeoff/landing corrections.

25. A method of operating an autonomous unmanned aerial system having a plurality of autonomous unmanned aerial vehicles (UAVs), each UAV comprising a flight control unit (FCU) and vehicle sensors operative with the FCU to provide real time position, orientation and velocity of the UAV during flight, and a UAV flight controller and flight actuators operative with the FCU that control UAV flight along a preplanned flight trajectory, the method comprising:
generating within an autorouter at an Air Traffic Controller (ATC) a preplanned flight trajectory for each of the plurality of UAVs operating within a defined geographical area of operation (AO), each preplanned UAV flight trajectory having a trajectory start time and position and a trajectory end time and position within the geographical AO, each preplanned UAV trajectory being deconflicted from the other preplanned UAV flight trajectories in position, velocity and time such that the preplanned flight trajectory for each UAV is conflict free from the other flight trajectories of other UAVs operating within the geographical AO;
each UAV flight trajectory comprising a plurality of preplanned trajectory waypoints defining flight segments, each flight segment comprising a parabolic function for each of X, Y and Z positions projected separately as a function of time;
receiving and storing within each UAV FCU its preplanned flight trajectory;
initiating the flight of each respective UAV according to its stored, preplanned flight trajectory starting at its preplanned trajectory start time and position;
during flight, receiving data within each FCU from respective vehicle sensors and processing real time position, orientation and velocity of respective UAVs during flight and for the beginning of each flight segment;
computing a new position and velocity for each corresponding flight segment;
updating the parabolic function for each of the X, Y and Z positions projected separately as time for each respective flight segment to correct for any errors in the flight of the respective UAV;
operating the flight controller to control the flight actuators at the respective UAV and correct for any deviation in the flight of the respective UAV within that flight segment and bring the respective UAV back on time, on position and on velocity by the end of that flight segment corresponding to the next successive waypoint as established by the preplanned flight trajectory; and
repeating for each respective flight segment to maintain flight of the UAV along the preplanned flight trajectory and in a deconflicted manner with other UAV's operating within the geographical AO.

26. The method of claim 25 wherein each preplanned flight trajectory comprises an Avoidance Limit (AL) as an area around the respective UAV flying its preplanned flight trajectory at every point in time that allows for errors induced by wind and load variations and slight trajectory deviations.

27. The method of claim 26 wherein for each segment of the flight trajectory, the FCU updates the parabolic function for each of the X, Y and Z positions such that the UAV reaches the next waypoint at the prescribed time and position and stays within the Avoidance Limit.

28. The method of claim 25 wherein the vehicle sensors in each UAV comprise a GPS device and Inertial Measurement Unit having an accelerometer and gyroscope.

29. The method of claim 28 wherein the vehicle sensors in each UAV comprise a LIDAR (Light Detection and Ranging) device that generates 3D map data to the FCU to process for obstacle avoidance within each segment of the preplanned trajectory.

30. The method of claim 25 wherein each FCU generates a new parabolic function as a parabolic curve for each of the X, Y and Z functions that converges to the correct position, velocity and time of the next successive waypoint corresponding to the beginning of the next successive segment in the preplanned flight trajectory of the respective UAV.

31. The method of claim 25 wherein the flight actuators for each UAV comprise at least one of drone motors and guidance components.

32. The method of claim 31 wherein the FCU generates a template curve at each flight segment during flight deviations based on a third order polynomial velocity function defining a sigmoid for an actuator control signal having a defined number of actuator steps to achieve an overall change from an initial actuator step value to a final actuator step value defined by the sigmoid, and said flight controller in response controlling the vehicle actuators in a non-linear manner to smooth transitions when a flight deviation is required during drone avoidance maneuvers, mid-flight trajectory changes and takeoff/landing corrections.
